(19) United States
(12) Patent Application Publication
(10) Pub. No.: US 2013/0311875 A1
(43) Pub. Date: Nov. 21, 2013

(54) WEB BROWSER EMBEDDED BUTTON FOR STRUCTURED DATA EXTRACTION AND SHARING VIA A SOCIAL NETWORK

(71) Applicants: Derek Edwin Pappas, Palo Alto, CA (US); Dragan Vujovic, Novi Beograd (RS)

(72) Inventors: Derek Edwin Pappas, Palo Alto, CA (US); Dragan Vujovic, Novi Beograd (RS)

(21) Appl. No.: 13/868,664

(22) Filed: Apr. 23, 2013

Related U.S. Application Data
(60) Provisional application No. 61/636,910, filed on Apr. 23, 2012.

(51) Int. Cl. G06F 17/22

(52) U.S. Cl. CPC G06F 17/2247
USPC 715/234

(57) ABSTRACT

The present invention is directed to a system and method which users can use to identify data base elements in a web page, store the extraction template representing the location and type of elements on the page, extract and store the product record in their collection, use the extraction template to automatically extract all the data from the web site and constantly check the extraction templates for correctness and update the extraction templates if necessary. Additionally, the present invention system provides crowd sourced web page data record extraction template creation to build a database of web page extraction templates which could then be used by others to extract the information from the web pages at the site where the extraction template(s) were created, and to save the information to a social network. Moreover, crowd based web page data record extraction template creation and storage system can be used to create extraction templates for batch extraction of information from remote web sites. Also, the data record information extracted from the web page to find the same or similar products at other web sites can be sited in a central product record data base that is created with the previously mentioned batch extraction system.

### CROSS-REFERENCE TO RELATED APPLICATIONS

The present application claims the benefit of U.S. Provisional Application No. 61/636,910, filed Apr. 23, 2012, by Derek Edwin Pappas and Dragan Vujovic and titled “Web Browser Device For Structured Data Extraction and Sharing Via a Social Network”, included by reference herein and for which benefit of the priority dates are hereby claimed.

### FEDERALLY SPONSORED RESEARCH

Not applicable.

### SEQUENCE LISTING OR PROGRAM

Not applicable.

### FIELD OF INVENTION

The present invention relates to Internet data search and information extraction technologies and social networks.

### BACKGROUND

It is understood by those skilled in the state of the art that the web browser device can be a browser bookmarklet, a browser extension or some other method that allows a user to execute the web browser device functionality on a remote site.

Structured data is typically stored in relational databases or some other form of table structure that may be hierarchical and have relationships between tables. The structure can be represented with a template. Structured data in web pages has a structure that is repetitive in nature from document to document. The web site generation templates used for generating the web pages that contain product records are created by one person and are typically not downloaded from a central source. Content management systems, which are sold or downloaded, contain generation templates that are customized by the web designer responsible for the creation of the website. Different sites may use the same content management system. However, the resulting HTML on two sites using the same content management system and generation templates do not necessarily have the same HTML structure. Moreover, it is not really possible to know that two web sites have used the same content management system and templates. Online shopping site generators offer stores different templates which are used to generate their online stores. Again, it is not possible to know what template was used to generate the store front, and the store front can be customized. This leads to differences between two different store fronts that were generated from the same template. Structured databases and generation templates are used to generate product pages at manufacturer and retailer websites. The product pages contain most or all of the same information as the product record in the database. The product web page is generated with a generation template. The product record is embedded in a markup structure (HTML) in each web page. The generation template or HTML layout structure which holds the product record may vary slightly from page to page due to differences such as the presence of a sale price on one page and no sale price on another or variable numbers of specifications from page to page or advertisements. Capturing the product record on any web page at the same site is a matter of knowing the layout of the structure that contains the product record. An extraction template which contains XPATHs and semantic information (the data field name) has been used in solutions to capture and save web based information to data records in order to analyze the information, use the information in reports, and for other purposes. Kapow has web data extraction capabilities for a single web site using wrapper technology. They also have data normalization and data transformation capabilities including text and code strings, numbers, date and time, HTML/XML. Fetch.com compares pairs of pages using algorithmic “experts” (e.g. computer algorithms) to find similarities between the pages, forms clusters out of matching pairs, extracts the data from the clusters and stores the data in the data base. (Publication number EP1910918 A2). Socially curated sites do not create an extraction template for the data record, nor extract the data record, nor transmit, nor store the entire data record from the remote web page.

Social networks utilize buttons on remote web sites to capture information from the web page normally send links or small amounts of data from the remote page via Facebook like or Twitter Tweet buttons (shortened URLs) from sites to their respective destinations, Facebook or Twitter. It would be beneficial to send complete data records from sites containing the data field names and the corresponding data field values from pages at sites for the purpose of creating user curated data which can be indexed and searched. There is also a need for a system that transmits the data records, cleans the data records, classifies the data records, normalizes the data records, stores the data records in a database index and displays the data records on a socially curated site.

Users save the unstructured data from product web pages using widgets, buttons or browser extensions from socially curated sites such as Wanelo, Pinterest and Clipix. Socially curated sites allow users to save a title and select a picture and a price to save on a page to their list, collection or board. The unstructured data contained on socially curated networks is captured on remote sites and saved to user collections. “Unstructured data” in the case of product records means that the data is not organized into name/value pairs such as “price” and “$10”. Sites such as Pinterest, Wanelo, and Shopcade extract the title of the page, search for an image near the top of the page or let the user select the image, and search for a price near the selected image. They send the extracted information to their popup, the user selects a collection to add the data to, and the record is then added to the collection. The socially curated web site does not receive the contents of the entire original data record, no cleaning, classification or normalization actions are performed. They do not extract complete information from web pages and associate semantically analyzed text with data field names and store the information in data records. An example of text which has semantic meaning is a token(s) consisting of alphabetic characters that represent a manufacturer name. Consequently, there is a need for semantic analysis after the text that is associated with a data field name is extracted from the page. Currently, socially curated sites do not do semantic analysis of the text that is extracted from the remote web site to create data records that are displayed on the user's collection. The one data value that they may extract automatically is the price nearest the product image.

Product sites such as brand and retailers contain product records in web pages. Web servers use generation templates to render product records stored in data bases on the web pages. Systems to manually identify data base records and their elements in the web page have been built to scrape the information from entire web sites. Systems to extract an image and a title, such as Pinterest or the photo image and manual/semiautomatic price extraction such as Wanelo, and store that information in a user's collection do not know about the web page template. There is a need for a system which users can use to identify data base elements in a web page, store the extraction template representing the location and type of elements on the page, extract and store the product record in their collection, use the extraction template to automatically extract all the data from the web site and constantly check the extraction templates for correctness and update the extraction templates if necessary (ie., websites change their structure).

A formal definition of information retrieval is finding documents, which are typically unstructured text, that match a query, from a large body of documents that are indexes.

Search results on product search engines typically include duplicate products which are not normalized from different retailers. Product search engine results do not typically include manufacturer records, which normally contain the most complete set of product attributes, including specifications. Thus, it is difficult to compare different products even if they can be found on the aggregated web site, since the detailed product information is missing, contains duplicates and is not normalized.

Current socially curated networks contain information which often does not contain all of the meta-data associated with the images that users have uploaded or captured from another website using a web browser device bookmarklet, extension or embedded button. Typically the title of the web page is extracted along with the image or the user types in a description. The unstructured data on these types of socially curated websites makes it difficult to index, search, and compare items on the social network. The current search process for products at shopping engines, retailers, manufacturers, and socially curated product sites is not as efficient as it can be.

These socially curated sites do not have a predefined template nor do they make and save a extraction template for the product sites. As a consequence a robot or user cannot revisit the site and extract the full product record from the sites using a previously created template and create a product database on their respective sites.

It would be beneficial to have a system which uses crowd sourced web page data record extraction template creation to build a database of web page extraction templates which could then be used by others to extract the information from the web pages at the site where the extraction template(s) were created, and to save the information to a social network. Moreover, there is a need for a crowd based web page data record extraction template creation and storage system that could be used to create extraction templates for batch extraction of information from remote web sites. Furthermore, there is a need for a system that uses the data record information extracted from the web page to find the same or similar products at other web sites in a central product record data base that is created with the previously mentioned batch extraction system.

### SUMMARY OF THE INVENTION

In accordance with the present invention, there is provided a method and system for the creation of extraction templates, extraction of product records using the extraction templates, categorization of the product data in the product record, normalization of the data field names and values in the product record, indexing, and tracking items of interest on the web. In addition, the product record information can be curated and integrated with the user's social graph. The information and extraction template represent the structure and content of the data record information on the web page. The extraction template database stores the extraction templates which are used by the external extraction button and the extraction system which extract data records from remote web pages and sends them to the search engine. The system provides significant advantages over current socially curated sites, shopping engines, and conventional search engines which typically index unstructured text from web pages or use data feeds. The creation of a central data record database by the present invention allows users at a web site to search for products efficiently. The normalized database allows users to compare products at a very detailed level using the specifications. The extraction, classification, and normalization of structured data, which are the data field values in the data records in the web page, create structures which can be searched in the similar way that a conventional database is searched. The structured data can be compared, and analyzed unlike unstructured data which is indexed by a search engine such as Google on the limited search capabilities in current shopping engines.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram of a data extraction system showing the data extraction flow.

FIG. 2 is a block diagram showing the different data records hidden in web pages. 39

FIG. 3 is a block diagram of an HTML Tree.

FIG. 4A is a diagram showing the web browser device installation process.

FIG. 4B is a diagram showing the process of starting the web browser device on the product site.

FIG. 4C is a diagram showing the web browser device panel appearing on the product page.

FIG. 4D is a diagram showing identifiers that appear on the page after the web browser device is started.

FIG. 4E is a diagram showing the right-click menu from which user can se DFN.

FIG. 4F is another diagram showing the right-click menu from which user can select the DFN.

FIG. 4G is a diagram showing the added field value in the web browser device panel.

FIG. 4H is a diagram showing the process of selecting the specification DFN and DFV from the page.

FIG. 4I is a diagram showing the web browser device populated “Data” tab.

FIG. 4J is a diagram showing the web browser device populated “More data” tab.

FIG. 4K is a diagram showing the web browser device populated “Spec” tab.

FIG. 4L is a diagram showing the web browser device buttons that enable user to clear or edit the (populated DFV's.

FIG. 4M is a diagram showing the web browser device buttons that enable user to mark the populated MN's as constants.

FIG. 4N is a diagram showing the web browser device “Submit” button which user can click in order to save the populated data.

FIG. 4O is a diagram showing the submit pop-up window with extracted and cleaned product data shown.

FIG. 4P is a diagram showing the submit pop-up window with extracted product data that was reverted.

FIG. 4Q is a diagram showing the submit pop-up window with extracted images.

FIG. 4R is a diagram showing the submit pop-up window with extracted product description.

FIG. 4S is a diagram showing the submit pop-up window with extracted product specifications.

FIG. 4T is a diagram showing the process of selecting the collection and a reason for adding a product.

FIG. 5 is a block diagram of a data extraction system showing the find operation using an extracted product record.

FIG. 6 is a flow chart of a data extraction system.

FIG. 7 is a flow chart of the template checking system.

FIG. 8 is a block diagram of a computer system.

FIG. 9 is a block diagram of a distributed system.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

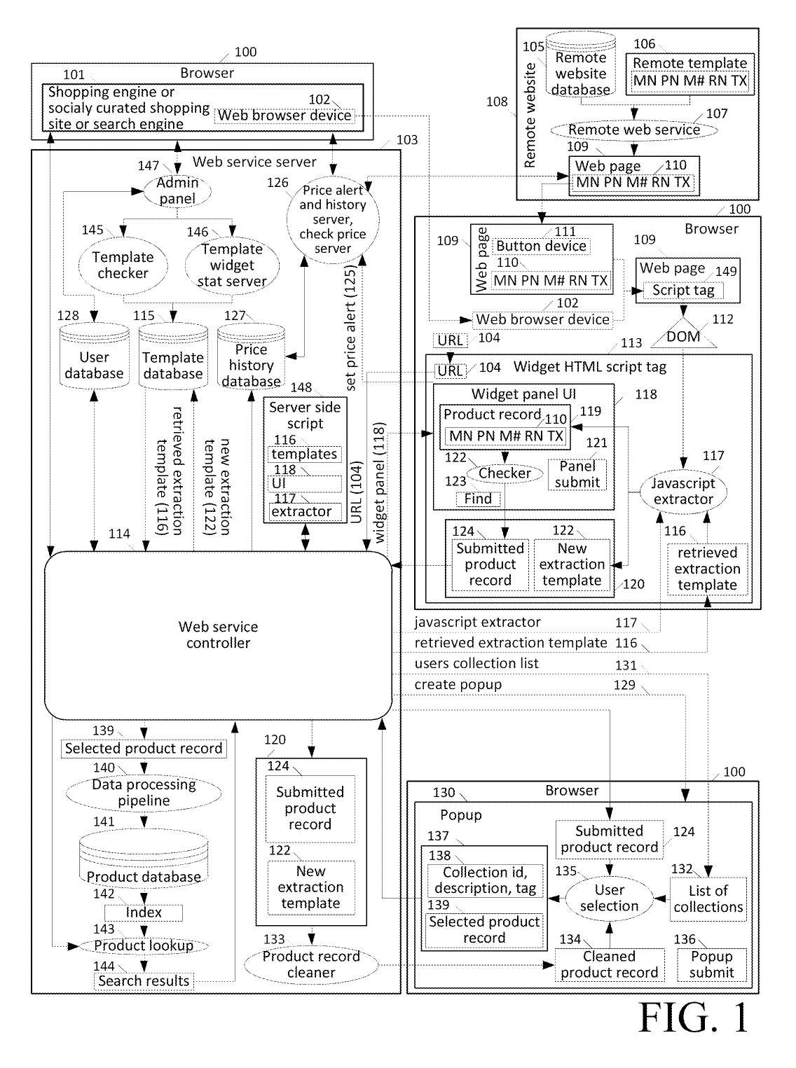

FIG. 1 shows the system operation when the user presses the web browser device (bookmarklet or button or extension) to extract visible or hidden data. The user will register at the shopping engine or socially curated shopping site or search engine 101. User can then go to a remote third party site 108 generated by a remote web service 107 which contains products which are stored in a structured data format generated from a remote product or other structured data website database 105 and a remote web site template 106 which produce a remote web page 109 which contains the product record 110.

Then the user clicks on the web browser device containing javascript code, which can be an embedded button 111, extension or bookmarklet 102 in the browser 100. When the widget, extension or button is pressed the product record 110 embedded in the web page 109 is extracted using one of the methods described later in this patent. When the user presses the web browser device 102, the javascript is executed by the browser 100 using the ability of the browser to execute JavaScript in the address bar. Or the user presses the button 111 in the page, which contains the web browser device JavaScript code which executes the web browser device JavaScript. The web browser device JavaScript code creates an HTML script tag 149 in the page 109 which points to a server side script 148 that will be created on the web service server 103. The HTML script tag 113 passes a URL 104 argument to the server side script 148 as an argument. The web service server 103 will extract the root URL from the sent URL 104 and look up the retrieved extraction template(s) 116. The server side script 148 is created on the web service server 103 which contains the merged site extraction template(s) 116 for the root URL associated with the URL 104, widget panel user interface code 118, and the JavaScript extractor 117. The modified HTML page 109 that contains the injected HTML script tag 149 is converted to the DOM representation 112 by the browser 100. The browser then executes the server side script 148 which downloads the elements to and creates the following elements in 113 in the browser: the web browser device panel 118 which appears in the product page tab, the javascript extractor 117, and the merged site extraction template(s) 116. If a template was retrieved then the XPATH in each tuple is looked up in the DOM and the product record 119 is extracted and inserted into the widget panel UI 118 data fields.

If no template was returned by the web service server 103 or the page has changed or there is missing information then the user selects that product information in the web page. This is described in detail later in the patent. The information that the user selects in the web page is checked for semantic errors, string too long errors and other types of checks by the checker 122. After the user selects the product information in the web page and populates the panel the user presses the panel submit button 121 the web browser device sends the submission container 120 which contains the submitted product record 124 and the new extraction template 122 which contains the list of tuples (data field name, data field value, XPATH, semantic type) in a post key/value form to the web service server 103. If the user selected a price alert option for the product in the web browser device panel, then the set price alert message 125 is sent to the price alert and history server 126 which then stores the price alert in the price history database 127. Optionally the user can press the find button 123 to search for products in the product database 141.

The web service creates a pop up 129 and sends the user's list of collections 131 and the submitted product record 124 is sent to the pop up.

The web service will send a template record which contains the URL of the page 104, the new extraction template 122 from the web browser device and submitted product record 124 from the web page 109 to the data cleaner 133. The cleaner 133 will clean the product record and send a cleaned product record 134 to the pop up 130.

The user then can select 135 the cleaned data record 134 or the submitted product record 124 data field value(s). Also, the user can select a collection from the list of collections 132. The pop up sends the resulting set of selected information 137 containing the selected product record 139 and the collection information 138 to the web service controller 114 after the user clicks on the pop up submit 136.

The web service sends the selected product record 139 to the data processing pipeline 140. The selected product record is then inserted into a product database 141. The index 142 is created with the product records from the product record database. The index is queried by the product lookup 143 which returns product search results 144 through the web service controller 114 to the shopping engine or socially curated shopping site or search engine 101.

The page with the given URL 104 is downloaded by the cleaner 133 and the HTML parser creates the DOM 112 using the page.

The web service then performs the following operations: (1) the server generates a unique identifier. The product page URL 104 is hashed to a 256-bit UUID by the web service 114; (2) the web service sends the unique identifier and the user collection identifier to the user database 128 where the unique identifier is added to the user collection 128; and (4) the server sends the unique identifier the extraction template in JSON form 122 to the extraction template database 115. The XPATH and the semantic type are used to extract data field values from pages on the site and associate them with data field names. Pages on the site are constructed from the same remote template 106. The new extraction template 122 contains the list of tuples (a tuple consists of the following: data field name, data field value, XPATH, semantic type).

The user and others can see the selected data record 139 that was inserted into the collection specified by a collection id 138 on their profile page on the socially curated website 101. Periodically a job is run to generate a new index 142 from the product database 141 to make it easier to search for the products in user collections.

In one embodiment of the present invention, a user identifies the structured data in the page, associating data field names with the data field values and the system extracts the product record and creates a extraction template for future use. Alternatively, the web master adds a hidden data record which can be extracted using an embedded button.

Search engines index words and phrases. Attempts to extract structured data in web pages have been made by search engines using special markup in the web pages such as RDF, good relations, micro format and rich snippets. The web designer inserts the industry standard structured data formats into the web page to create data records in the web pages. The search engine crawls the site and examines the web pages for the presence of industry standard structured data formats. The industry standard structured data formats identify the data field values using a set of data field names. A method for extraction of structured data from a page containing a visible and invisible data record at a site using an identifiable invisible data and layout format is shown when a web browser device button 102 is pressed on the web page. The data record is located in a set of HTML tag(s) with corresponding data field names. An aspect of the present invention provides that a 3^{rd} party predefined set of data field names are used to enclose the data field values on the page. 3^{rd} party data field names are placed in attributes next to the data field values in the HTML tags.

The extraction engine searches for or is passed a location argument or XPATH directing it to the hidden data record and extracts the XPATHs, data field name/data field value pairs. The visible text on the web page contains the data record, typically only the data field values without the corresponding data field names. The identifiable invisible data and layout format containing the database record is inserted into the HTML page as invisible text (not visible to the viewer but in the page) or the invisible data field names are inserted next to the corresponding data field values using a web site template, just as the visible text containing the data record data field values and optional data field names is inserted into the HTML page using the website template. The 3^{rd} party predefined set of data field names and the corresponding data field names, may also contain a set of XPATH's to the marked up data record fields so that extraction templates can be created to extract data using the same markup template automatically from other pages using the same web site template from the same site.

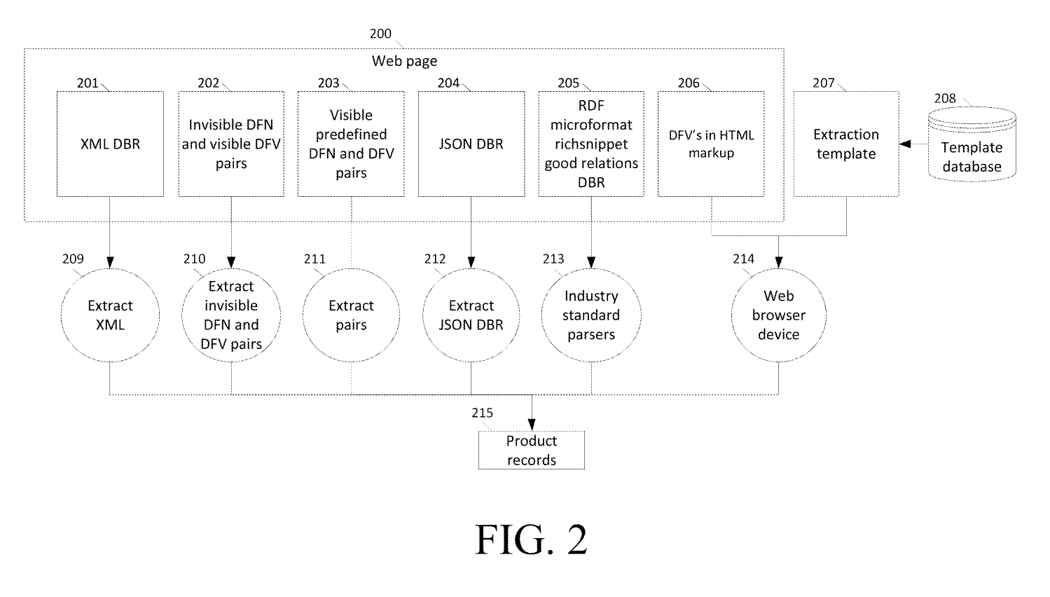

FIG. 2 shows different examples of the ways that data records visible on the web page 200 are hidden in structured data markups. The DFVs must be visible in the page to avoid an SEO penalty by a search engine. The visible data field name (DFN) is optional. The invisible DFN and invisible data field value (DFV) are optional. The data base records (DBR) can be stored in product information web pages (FIG. 2, 200) in several different ways: 1) XML DBR 201; 2) Invisible DFN and visible DFV pairs 202; 3) Visible predefined DFN and DVF pairs 203; 4) JSON DBR 204; 5) DBR's stored in RDF, good relations, micro format and rich snippets 205 formats; or 6) DFV's in HTML markup 206.

The industry standard formatted structured data is extracted into a data structure or record which is then inserted into a database or data table. The database or data table can then be further indexed to provide better search results for end users. Identifying product pages with fine grained searches that contain detailed information is then possible. However, web masters have not embraced industry standard structured data formats and only a small percentage of the web sites are currently using industry standard structured data formats designed to assist conventional search engines in extracting structured data. The structured data formats are not being inserted into the pages.

Still referring to FIG. 2, the hidden data record formats can be extracted from the web page using the following methods: 1) The XML DBR's 201 are converted by the extract XML block 209 to product records 215; 2) The invisible DFN and visible DFV pairs 202 are extracted by the extract invisible DFN and DFV pairs block 210 to product records 215; 3) The visible predefined DFN and DVF pairs 203 are extracted by the extract pairs block 211 to product records 215; 4) The JSON DBR 204 is extracted by the extract JSON DBR block 212 to product records 215; 5) The DBR's stored in RDF, good relations, micro format and rich snippets 205 are extracted by the industry standard parsers 213 to product records 215; and 6) The DFV's in HTML markup 206 are extracted by the web browser device extraction process 214 using extraction template 207 from the template database 208 to product records 215.

Referring back to FIG. 1, if the visible data field values in the visible data record have invisible data field names next to them hidden in HTML tags as properties then the java script extraction engine 117 will traverse the DOM 112, extract the hidden data field names and visible data field values in the visible data record, and present the data record on the web browser device panel 118. The invisible data field values are associated with the data field names in the web browser device panel. The web browser device panel will contain the visible data field values in the visible data record from that product page associated with the visible data field names in the panel such as manufacturer name, manufacturer logo, model number, price, etc 110.

Alternatively, the web browser device extraction engine can calculate the XPATH's from the root of the markup page to the hidden data values fields so that an extraction template can be created to extract data using the same generation template automatically from other pages using the same web site generation template from the same site.

Another embodiment of the present invention is a method for extraction of structured data from a page containing a data record at a site using a hidden duplicate data record, with the hidden data field names and value pair list in the HTML but not visible on the browser, when a button is pressed on the web page. An aspect of the present invention provides that a 3^{rd} party data record marker is used to enclose the data field names and value pair list on the page. The invisible data record is extracted from the web page as a block. The hidden HTML markup contains the 3^{rd} party predefined set of data field names and the corresponding data field values which are sent to the website's server when the button is pressed.

Other embodiments of the present invention include methods for extracting invisible data records, visible data records and partial data records. Still referring back to FIG. 1, if the invisible data record is embedded in the page then the Javascript extraction engine 117 will traverse the DOM 112, extract the invisible data record, and present the data record on the side panel. The web browser device panel 118 will contain a predefined information list 119 from that product page such as manufacturer name, manufacturer logo, model number, price, etc.

An example of an embedded record is below:

```
<a class=”website-embedded-record”
  href=”//website .com/”
  gapr_retailer_name=”<name>”
  gapr_brand_name=”<name>”
  gapr_product_name=”<name>”
  gapr_product_image_url=”<url>”
  gapr_model_number=”<model_number>”
  gapr_description=”<description>”
  gapr_retailer_logo_image=”<URL>”
  gapr_brand_logo_image=”<URL>”
  gapr_rating=”<number of stars/scale>”
  gapr_color_names=”<list of color names>”
  gapr_product_page_url=”<url>”
  gapr_feature_list=”<list of features>”
  gapr_specification_list=”<list of specifications>”
> </a>
```

The Document Object Model (DOM) is a cross-platform and language-independent convention for representing and interacting with objects in HTML, XHTML and XML documents. Objects in the DOM tree may be addressed and manipulated by using methods on the objects. The public interface of a DOM is specified in its application programming interface (API). The HTML DOM defines a standard way for accessing and manipulating HTML documents. The HTML structure is represented as a tree.

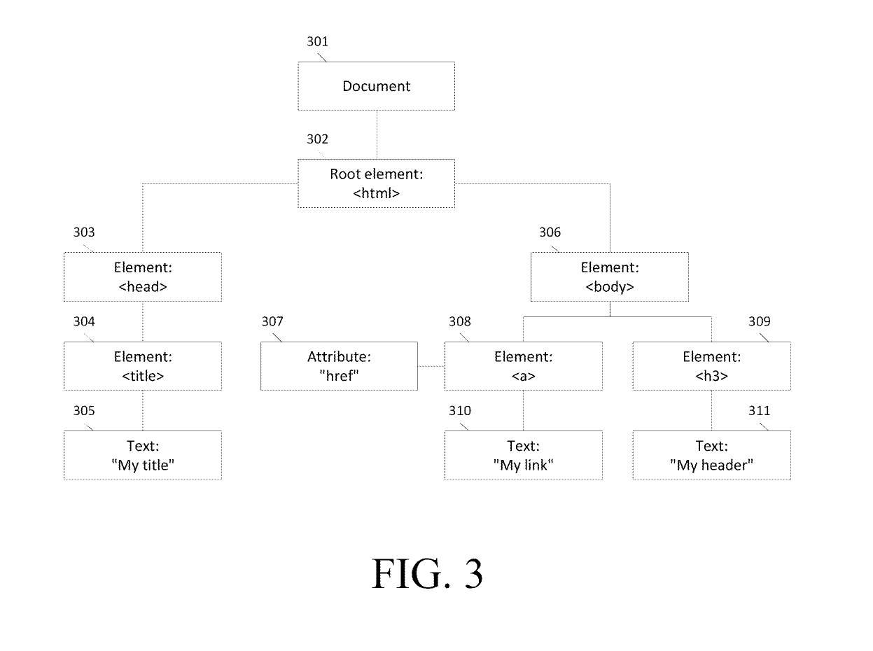

When a page is loaded into a browser, the browser domain object model (DOM) is constructed. The DOM is a tree-like representation of the HTML hierarchy, attributes, visible text, and other information in the HTML page. FIG. 3 shows an example HTML tree. On top is the HTML tree document 301, under is the root element 302, the head element 303, the title element 304, the text associated with the title 305, the body element 306, and the href attribute 307. The <a> element 308 contains text associated with the link 310. Element <hl>309 contains text associated with header 311.

XPath, the XML Path Language, is a query language for selecting nodes from an XML document. In addition, XPath may be used to compute values (e.g., strings, numbers, or boolean values) from the content of an XML document. XPath was defined by the World Wide Web Consortium (W3C). Tag pairs in an HTML product page contains text. The text can be product record data field names and values. The XPATH and data field name and value is created from a template and a data record.

The XPATH's in the web browser device extraction template are traversed by the Javascript extraction engine to find the data field values. The Javascript extraction engine thus utilizes the browser's existing DOM to find the data record information using the XPATH's in the web browser device extraction template(s).

A data record tuple contains a DFN and DFV. A template tuple contains a DFN, constant bit and XPATH. A data record is created from the list of data record tuples. A template record is created from the list of template record tuples. The data record tuple and template tuple are created when the user right clicks on the visible DFV in the web page and selects a corresponding DFN label. The DFN label is then added via additional HTML tags and text to the visible page. The selected DFVs are extracted and inserted along with their corresponding DFN into the data record.

The web browser device contains Javascript code which communicates with the website's server. The bookmark, extension or embedded button contains Javascript code which sends a request to remote IP address or a URL with the root URL of the site that the current page belongs to. The root URL is a key for one or more templates associated with the site in the web browser device template database. The extraction templates were created by users at the same site using the same or different pages containing data records. The extraction templates can have differences in the XPATHs and can contain different sets of the data field name/data field value pairs. The Javascript extraction engine determines whether it has previously stored a web browser device template on the website's template server or whether the page has a hidden data record based on the type of call to the website's server from the remote web page (e.g. button extraction of hidden data or template web browser device extraction). The website's server returns the list of templates and a Javascript extraction engine to the browser. The browser then executes the Javascript extraction engine code using the XPATHs and semantic information in the extraction templates to extract the data from the page and create a product record. The best matching XPATH for each data field name/data field value pair is used to extract the data. Variations in XPATHs due to child number differences are handled by traversing the different children below the point where the child numbers are indicated in the XPATH specification (e.g. the XPATH says that the data field value is on the third branch when in fact it is on the fourth branch on this page). Multiple templates can be stored for a single site and multiple templates can be returned to the web browser device and used to find data that may not be in the same location on all pages. If the extraction template does not exist then the user is prompted to make it.

Alternatively, the remote site can put the button on the web page and not put 3^{rd} party data field names in the page source. Web site admin will create the extraction templates for their site pages using the widget, button or browser extension as described above. In this case the Javascript extraction engine passes the data record values to web browser device extraction panel. Note that a site can have product records, music records, recipes, movie records, or any other kind of repetitive structured data. The user creates a new extraction template type to associate with the site or preexisting extraction templates are matched against the HTML page DOM. The Javascript extraction engine uses the extraction template to capture the product record information on the page and transmit it to the server. When a user presses the button in the web browser the extraction engine requests the set of site extraction template from the website's server. Note that there can be more than one extraction template for a site but in general there will only be one data record type (e.g. templates for product records). The site extraction template(s) are retrieved from a remote extraction template server. If the remote extraction template server does not yet contain an extraction template for the current page at the site, then the user is prompted to create one. The extraction engine then extracts the data values at each XPATH to form a tuple with the corresponding data field name. The advantage to the site in this case is that they only need to add the button, make a template for the page's template using the web browser device. The web pages at the site do not need to be modified. A further advantage is that the site is giving the user explicit permission to extract the data and there is no ambiguity about fair use of the data with respect to copyright. The site then gives users permission to copy the data from the site to a remote web site, to add the data to a collection on a remote web site, to store the data in a database at the remote web site.

Creating an extraction template for a repeating pattern in an HTML web page presents problems for extraction because there is a variable number of lines on each page that contains the repeating pattern on the web site. A repeating pattern in an HTML markup web page uses the same structure to hold information with multiple values, multiple name/value pairs, or a hierarchy of values. Examples of repeating patterns which contain product record information include specifications, colors, or features. Using the present invention user selects only one row, name value pair, or sub tree in the repeating pattern using the right click menu that is enabled by the web browser device. The selection of one element in a repeating pattern is sufficient because the path from the root of the HTML tree to the root of the repeating pattern sub tree is identical for each repeating pattern element by definition. The repeating patterns below the root of the repeating pattern sub tree root also contain identical paths and may contain additional identical sub trees, sub Xpaths, and optional sub trees. One method for the extraction of the name value pairs from the repeating pattern is a process of finding the parents of each of the root of each sub tree in the repeating pattern and extracting the specification attribute name and value pairs from the sub tree. Repeating patterns with tree like structures as shown in an example below are recursive in nature and have repeating patterns within repeating patterns. The same extraction method is applicable.

If the page contains a hidden data record, that mirrors the visible product information in a product web page, either a previously created web browser device extraction template can be retrieved from the extraction template database or the user can create a new extraction template. The extraction template is then used in conjunction with the Javascript extraction engine to extract the hidden product record.

Additional product information such as specifications, reviews, features and descriptions may be transmitted to the server to be added to the user's collection. The web browser device extraction template creation process identifies the rich attributes which are usually stored in repeating patterns such as a table or list and extracts them from the page. The automatic extraction process then extracts the rich attributes from the repeating patterns on each page and stores the data record in the database.

Data tables contain different values for different sizes of the same item. In the case of multiple specification values for a single product such as a bicycle frame the data table may contain a header or a left hand column which contains the data field names or values. The user can highlight the header or the left hand column and select data table header or data table left column and associate the header or column with a set of data field names. The data field names can be associated by selecting each individual element of the table header or left column. The user can then select the data portion of the data table. The web browser device then has the three pieces of information for the data extraction table template. The location of the data field name header or column, the names of the data field names and their associated canonical names, and the data field value columns or rows. The table can then be extracted by a server side process. The advantage of the data table extraction process is that in the example above bicycle frames from different manufacturers can be compared at different sizes (e.g. 56 cm, 58 cm, 60 cm) using the exact specifications for the frame size that the customer is interested in.

The extracted images and/or data records can be stored on a content delivery network offered by a 3^{rd} party service such as Amazon Web Services. In one embodiment of the present invention, automatic cleaning of extracted data and automatic extraction of repeating patterns such as specifications, features is performed at the server and not at the remote web site. Rewriting the HTML tag pair puts each line in its own tag pair and the individual data fields can then be selected by the user.

The website stores the extraction templates for each extraction template type in a data store. The key for retrieving the web browser device extraction templates is the root URL for the site the extraction template belongs to. The extraction templates include a list of extraction tuples, Each extraction tuple contains the XPATH to the data element, the data element type, the data element data field name, a boolean if the data is a constant and should not be extracted, and if constant the data value to substitute for the page value in future extractions on this page layout type on this site. When a user presses the web browser device button at a site where the data field names are not stored in the page, the client sends the server a request for the extraction template(s), which are then used to find the structured data on the page.

Still referring back to FIG. 1, alternatively the browser java script extractor 117 will send the URL of the page to the web service controller 114 which then attempts to retrieve the extraction template from the extraction template database 116. If the extraction template database contains the extraction template, the retrieved extraction template 116 is returned to the web service with the java script extractor 117. If no extraction template was found in the extraction template database the web browser device panel will display “No extraction template was found” message. The web service controller 114 sends the Java script extractor 117 to the browser Java script extractor. The browser Java script extractor will then check if the web browser device extraction template XPATHs and semantic types in the extraction template tuples match the XPATHs in the browser DOM and extract the data field values from the DOM to form tuples. The web browser device panel will contain a set of user selected data values from that product page such as manufacturer name, manufacturer logo, model number, price, etc.

The web device employs two different methods to extract the structured data from the web page: 1) Users first create extraction templates to extract structured data from web pages. Subsequent visitors to the same website do not need to create update or modify the extraction template using the web device unless the site changes; 2) The extraction system recognizes a predefined structured data format and auto extracts the data record.

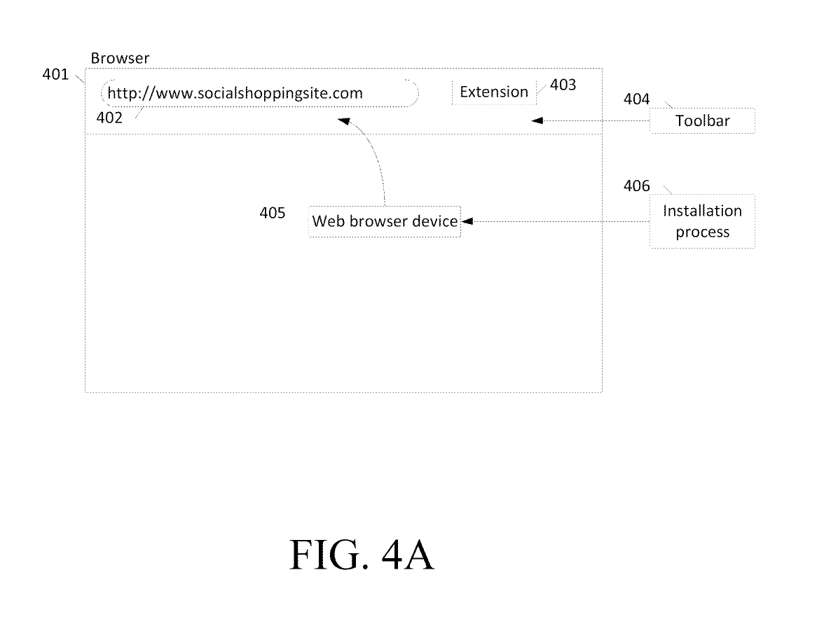

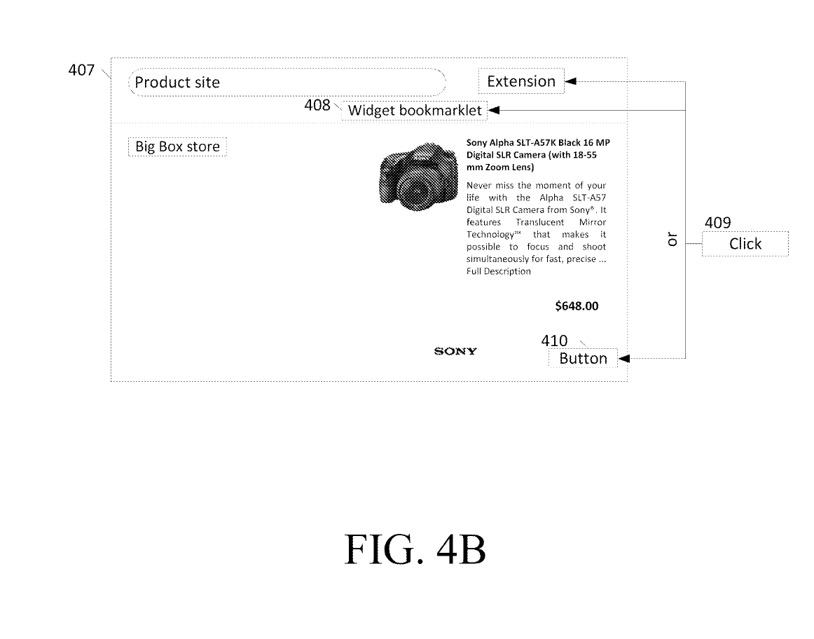

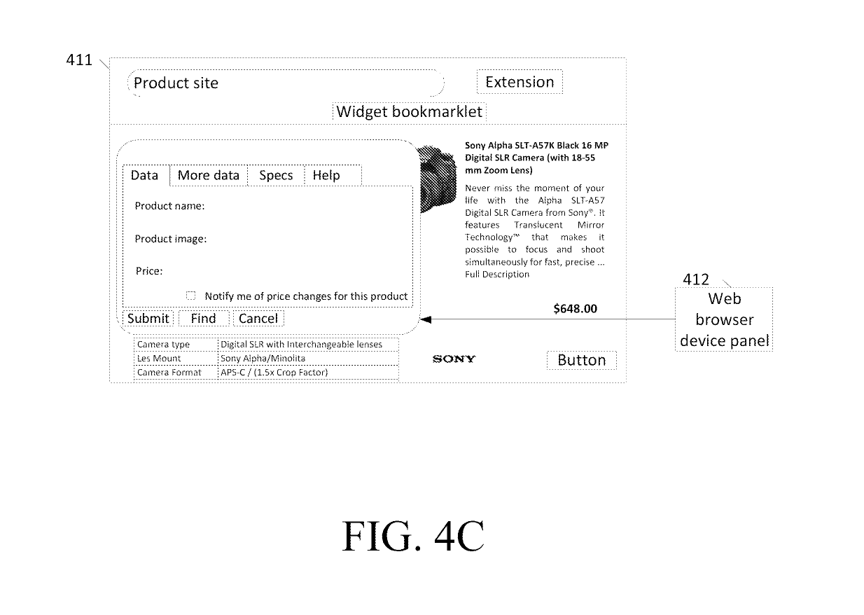

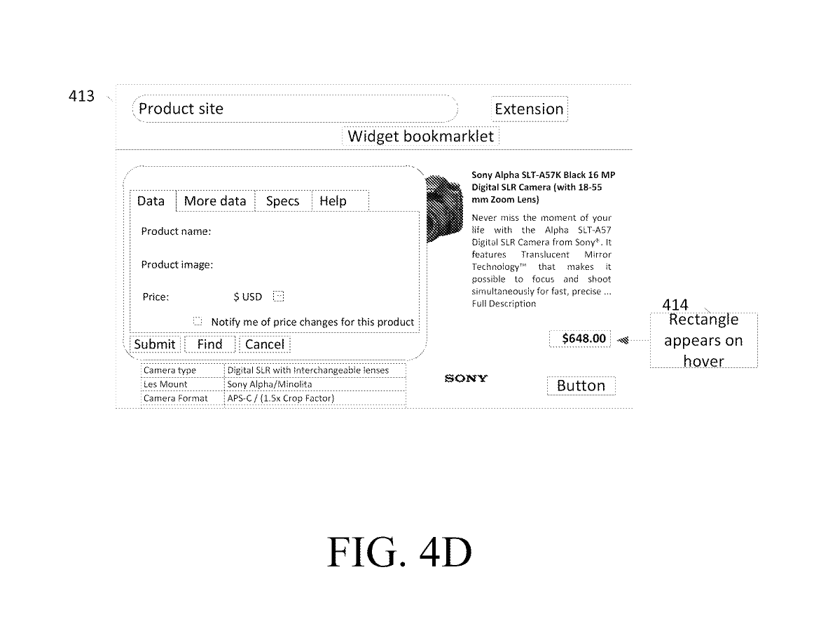

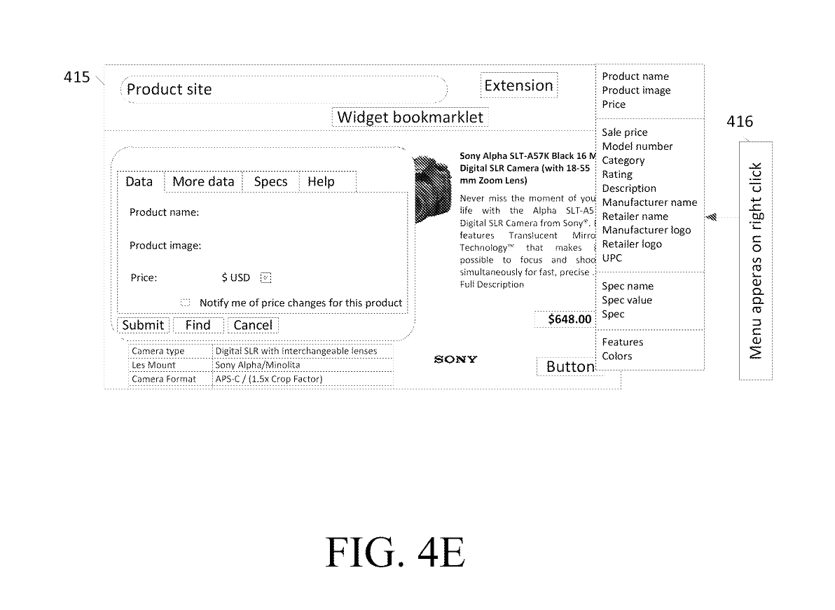

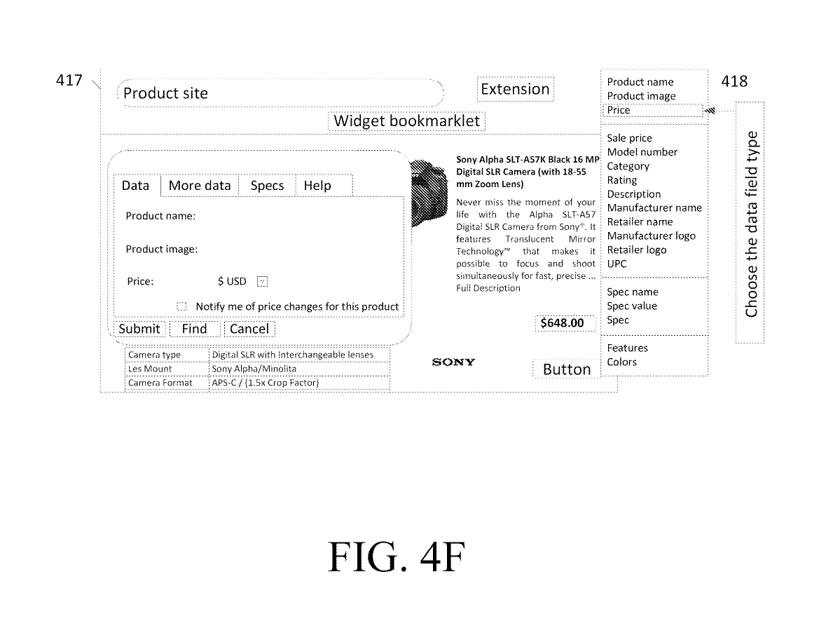

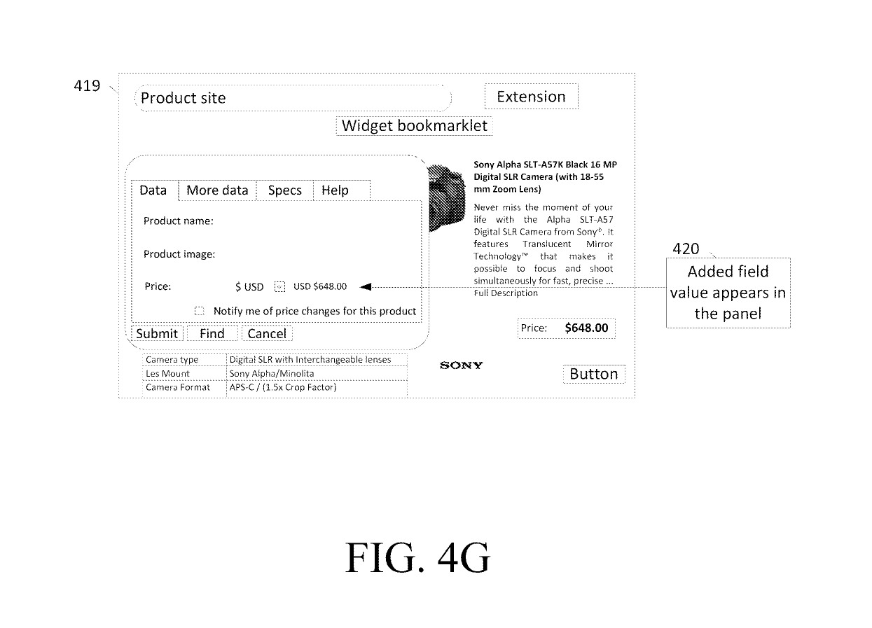

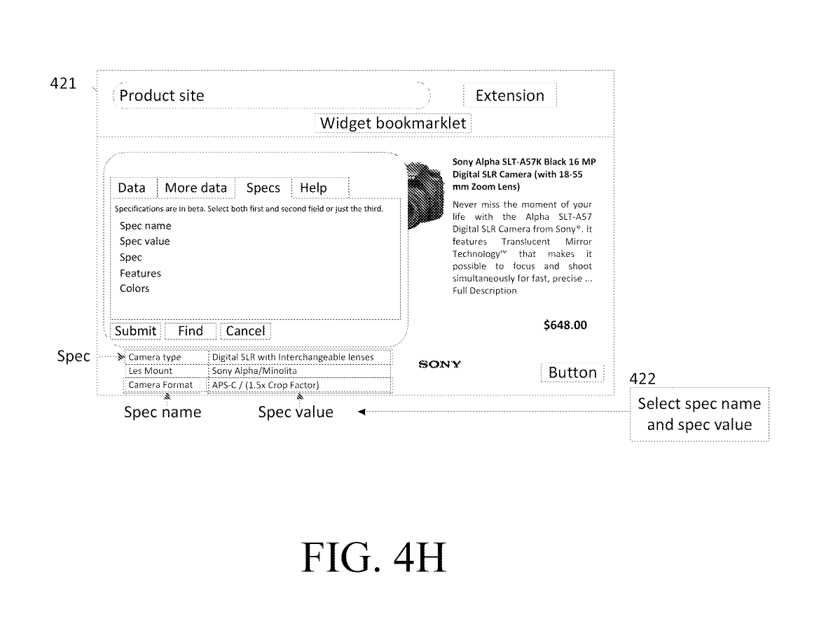

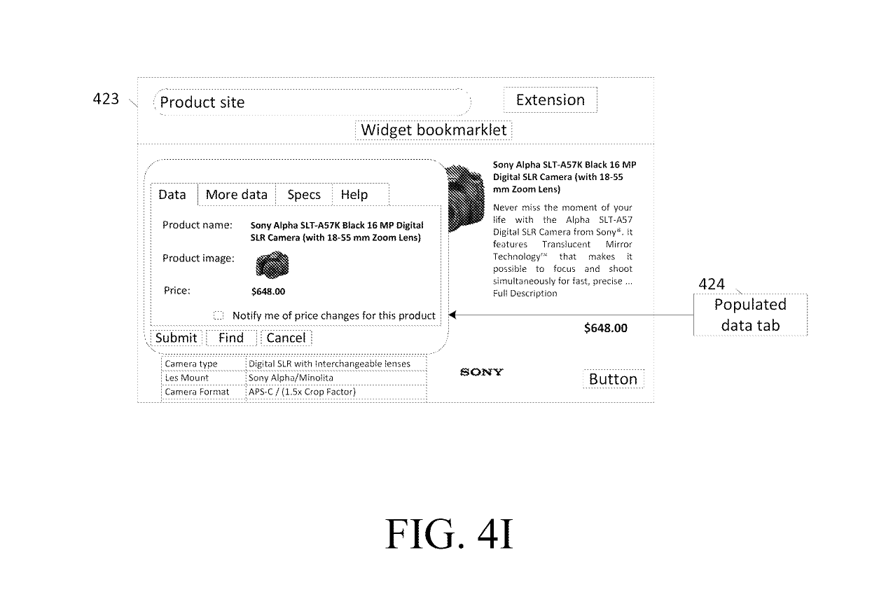

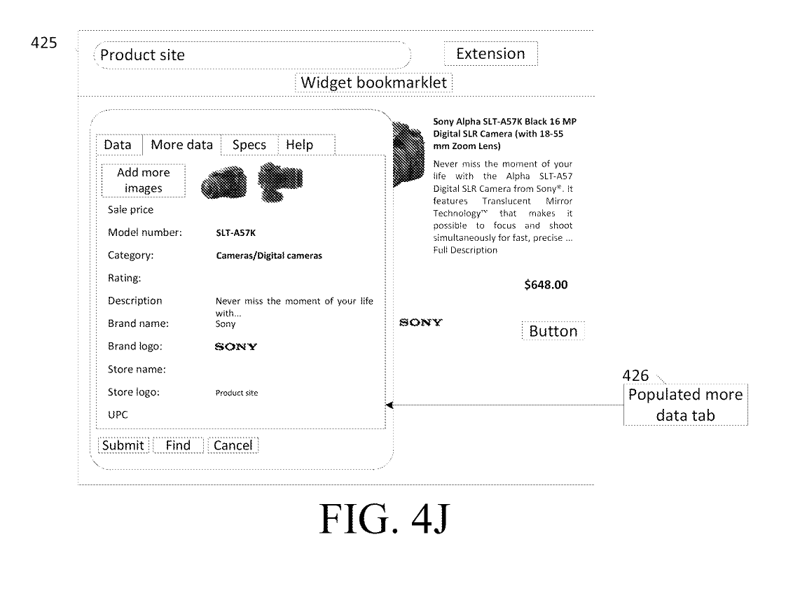

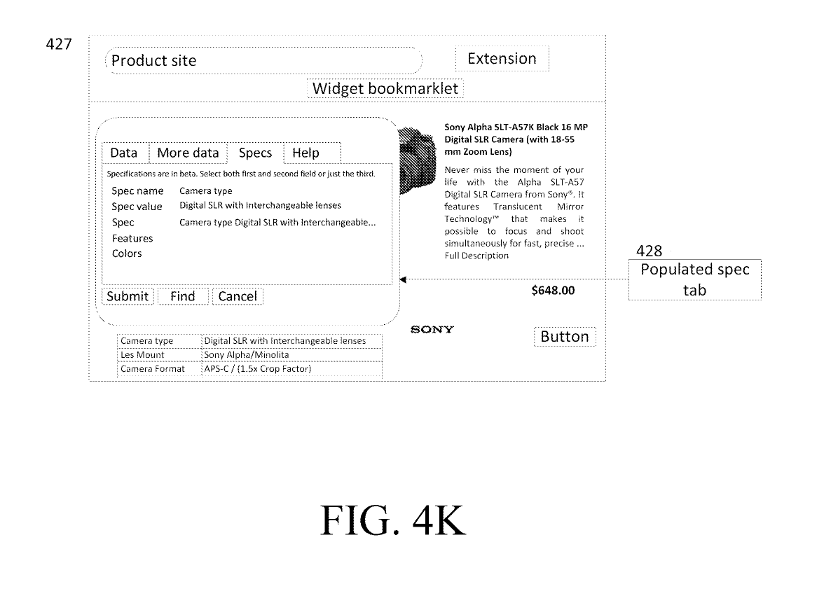

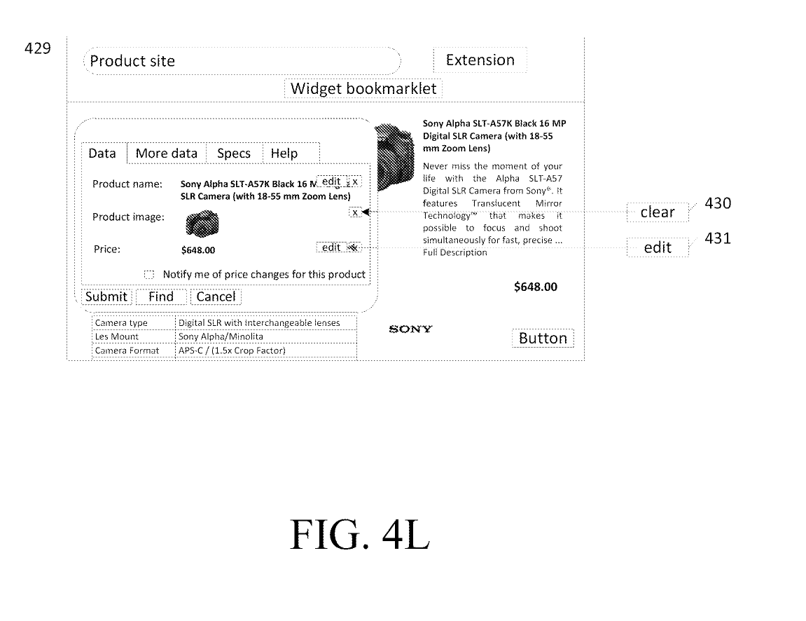

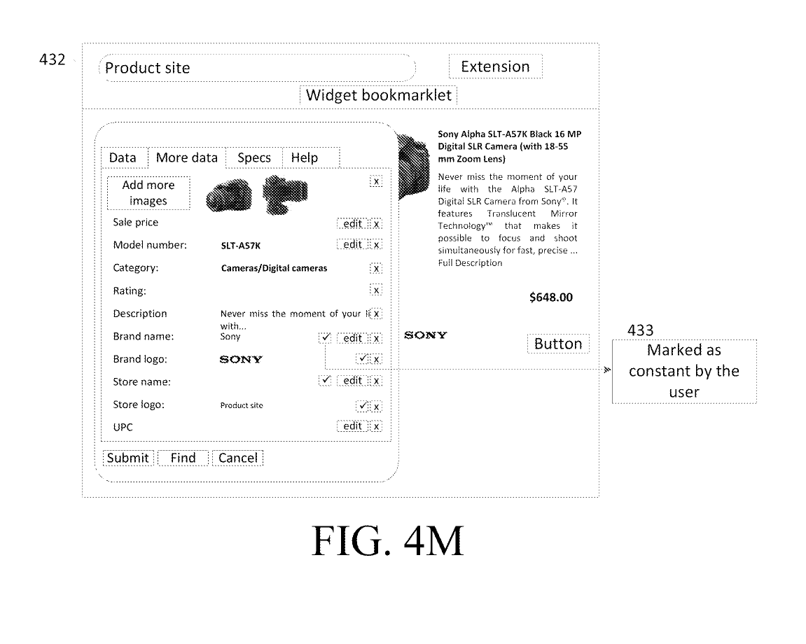

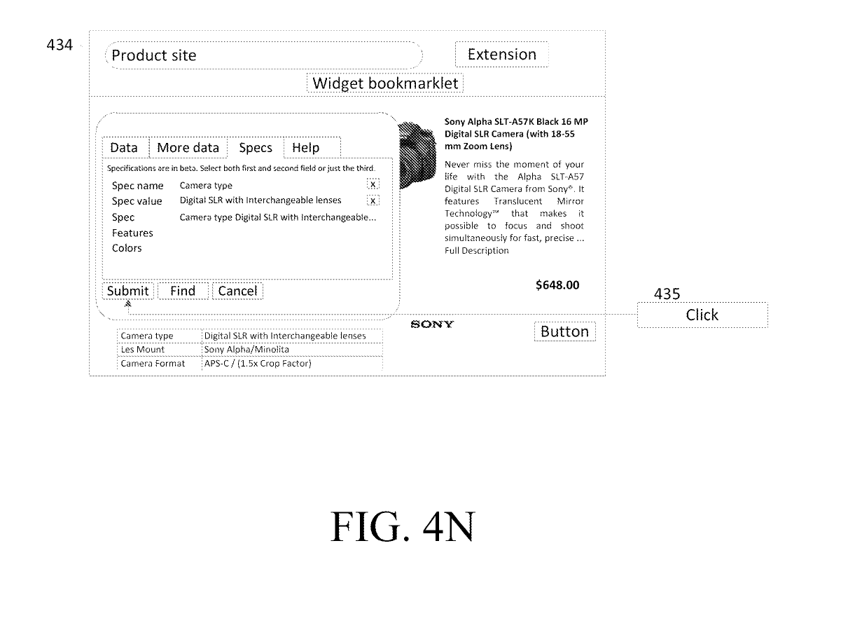

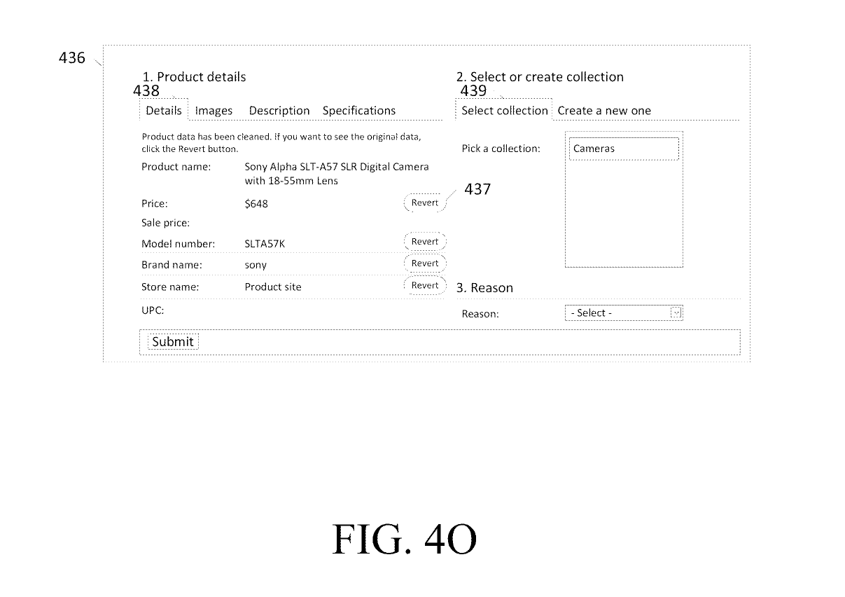

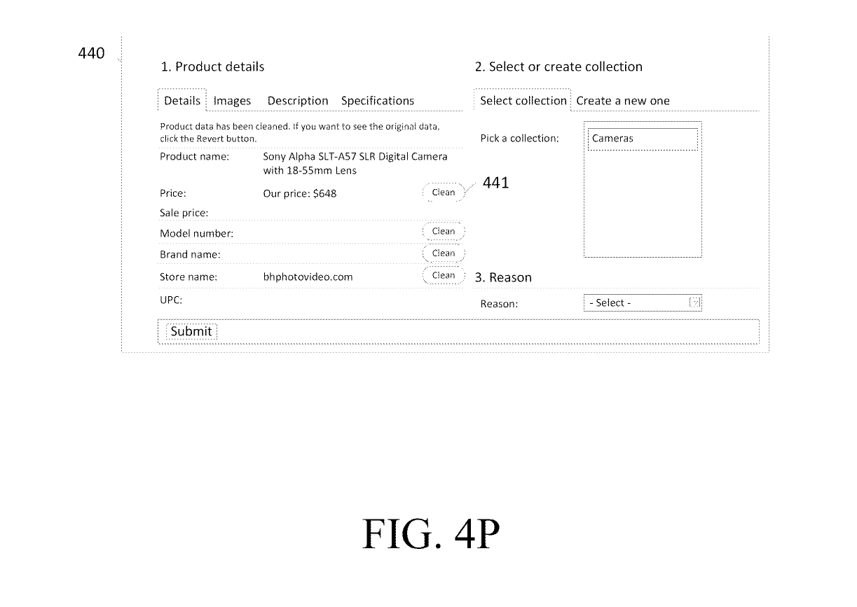

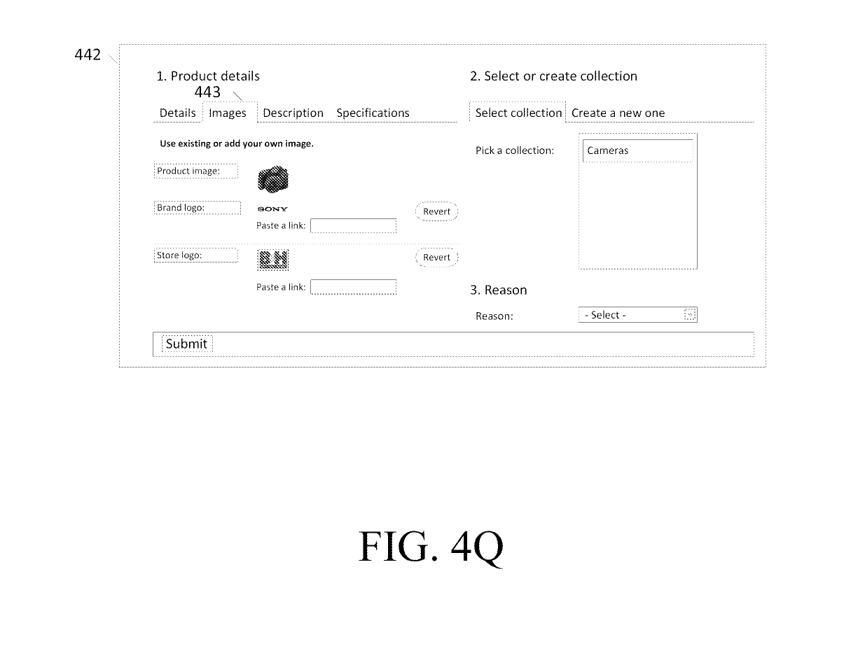

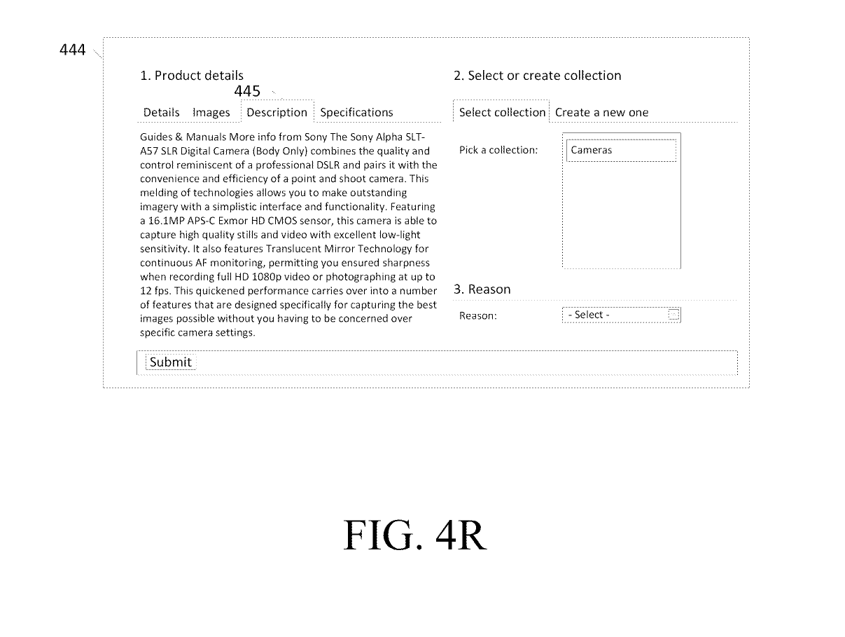

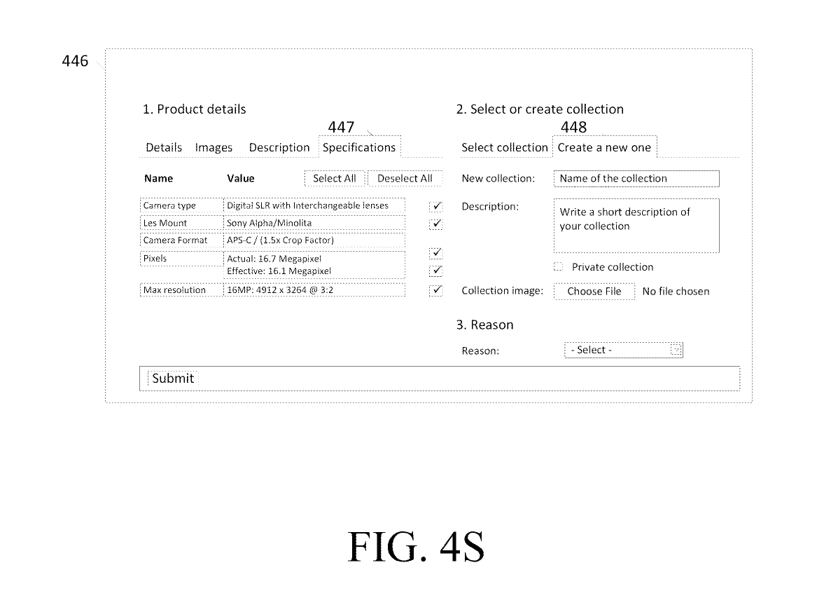

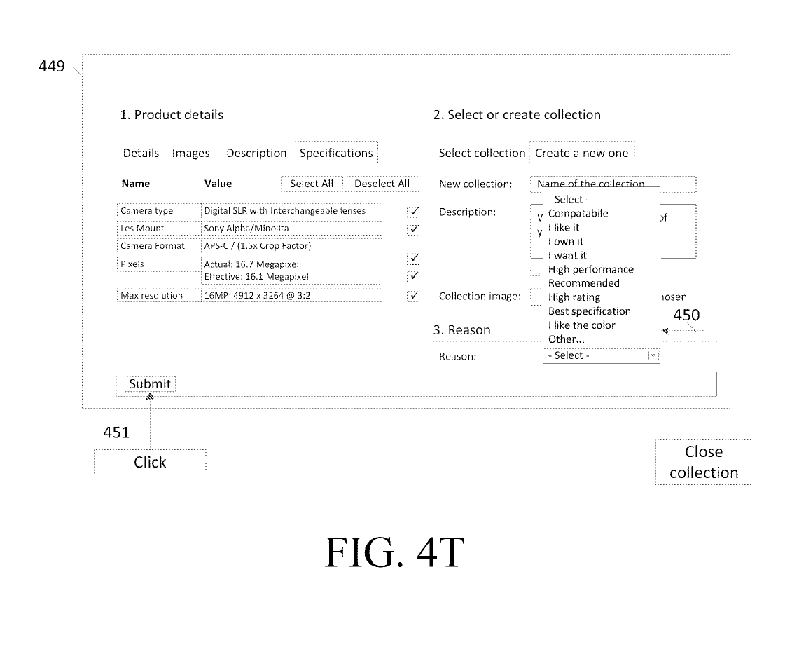

FIGS. 4A-4T show the web browser device flow. Turing now to FIG. 4A, the user navigates to the social shopping or search engine site in a web browser 401 via a URL 402. The user installs 406 the web browser device 405 to the toolbar 404 or adds the extension 403 to the toolbar 404.

The user navigates to a web page in a browser 401 via a URL (e.g. Best Buy), as shown FIG. 4B. The user then navigates to a single product page of interest on the retailer site 407. The web browser device is opened either by clicking 409 on the widget bookmarklet 408 on the browser toolbar 404 or extension 403 or by clicking 409 on the web browser device button 410 embedded on the remote HTML page.

If the user presses the button 410, and the page contains the hidden data record, the data record is extracted in its entirety and is inserted into the widget panel, and all of the fields become populated as shown in FIGS. 4I, 4J and 4K. In 4B after the clicking on the web browser toolbar button, extension or embedded button the web browser device panel 412 in FIG. 4C appears in the web browser page. Web browser device panel contains tabs, each of which contains data fields.

Turning now to FIG. 4D, if the panel is empty then the user adds the data field name/data field value pairs to the panel by hovering 414 over a data element where a rectangle will appear around the contents of an HTML tag pair.

Turning now to FIG. 4E, by right clicking on the data elements in the web page the menu appears 416.

FIG. 4F shows the user selecting the corresponding field in the right click menu 418.

In FIG. 4G is shown the widget panel with the selected product record information 420 from the web page, and thus, creating an extraction template. The Javascript extractor will compute the path from the root of the HTML markup to the data item and record it, along with the data field value and data field name. The data is presented to the user in the panel and data extraction template is created for the current site.

In FIG. 4H is shown the user selecting the specification attribute name (SAN) and value (SAV) or the entire specification (SAN/SAV) 422.

FIG. 4I shows the populated data tab 424 with the product name, product image, and price. The user can select an option in the web browser device panel to receive an alert when the product price changes on the online store, manufacturer or other product information. The price alert request will be sent to the price alert and history server. Price alerts can be set for a date range, a minimum or maximum price and other criteria which trigger a price alert. The check price server will periodically download the remote web page, extract the price and check it against the price range. An alert will be sent to the user if the price is in the alert range and the price change will be recorded in the price history database.

FIG. 4J shows the populated more data tab 426 which contains the additional product information.

FIG. 4K shows the populated specification tab 428 which shows the selected SAN/SAV pair or the selected specification.

FIG. 4L shows the clear 430 and edit 431 options on the panel. Clear is used to clear the contents of the field and the edit option is used to edit the contents of the field.

FIG. 4M shows marked as constant 433 check box which marks the field as a constant for all pages extracted with the template generated from the extraction template generated from this site.

FIG. 4N shows the click on submit button 435 which by pressing the user sends the template and the product record to the web services server.

FIG. 4O shows the pop up which contains the details tab 438 and the select collections tab 439. The data which was cleaned appears and each field can be reverted using the revert button 437 next to it.

FIG. 4P shows the reverted record. Each field can be cleaned using the clean button 441 next to the field.

FIG. 4Q shows the images tab 443 which contains the images and logos extracted from the page.

FIG. 4R shows the description tab 445.

FIG. 4S shows the specification tab 447 which shows the specifications extracted from the page by the server side extractor, which then sends the specifications back to the pop up and create a new collection tab 448.

FIG. 4T shows the reason why someone added the product menu 450 and the submit button 451 which the user presses to submit the product record to the web service.

Multi image extraction can be accomplished by the automatic identification of all images in a web page. The user is presented with a pop up showing all of the images and their associated meta data on the web page. The user then selects the images that they want to capture and display in their collection. The user can select one or more additional images on the page and submit them with the extracted product record. The additional images are shown on the extracted product page in the web site.

Ratings selection (technicalities such as the use of CSS to render the rating stars do not prevent the extraction and correct identification of the rating associated with the product on the page. Ratings appear in an HTML tag pair and the user selects the rating using the right click menu as described above. The rating is then added to the data record template and data record which is sent to the server.

The data field values are available for editing by the user via a form on the web browser device panel. The user can optionally edit the data field value prior to setting it to a constant and saving it. The data field value can be marked as a constant throughout the site. The user can set the data field value to a constant for fields which do not change from page to page.

Submit, find and cancel buttons are available on each tab. When a user presses the submit button in the web browser device panel the embedded data record which contains data field names and data field values in the section containing the data field values enclosed by the 3^{rd} party predefined set of data field names (which may be synonyms of a common set of data field names), the page URL, the user session data, and other interesting information on the page such as the breadcrumb and title is sent via a form to the website.

The data field values are embedded in the website's product record which uses the predefined set of data field names. Pressing the button will transmit the data record, which includes the list of data field name/data field value pairs. The extraction template which includes the XPATH and semantic type of the data field value, is sent to the server.

The web browser device can use the extraction templates and index to perform a search for the information on the product page.

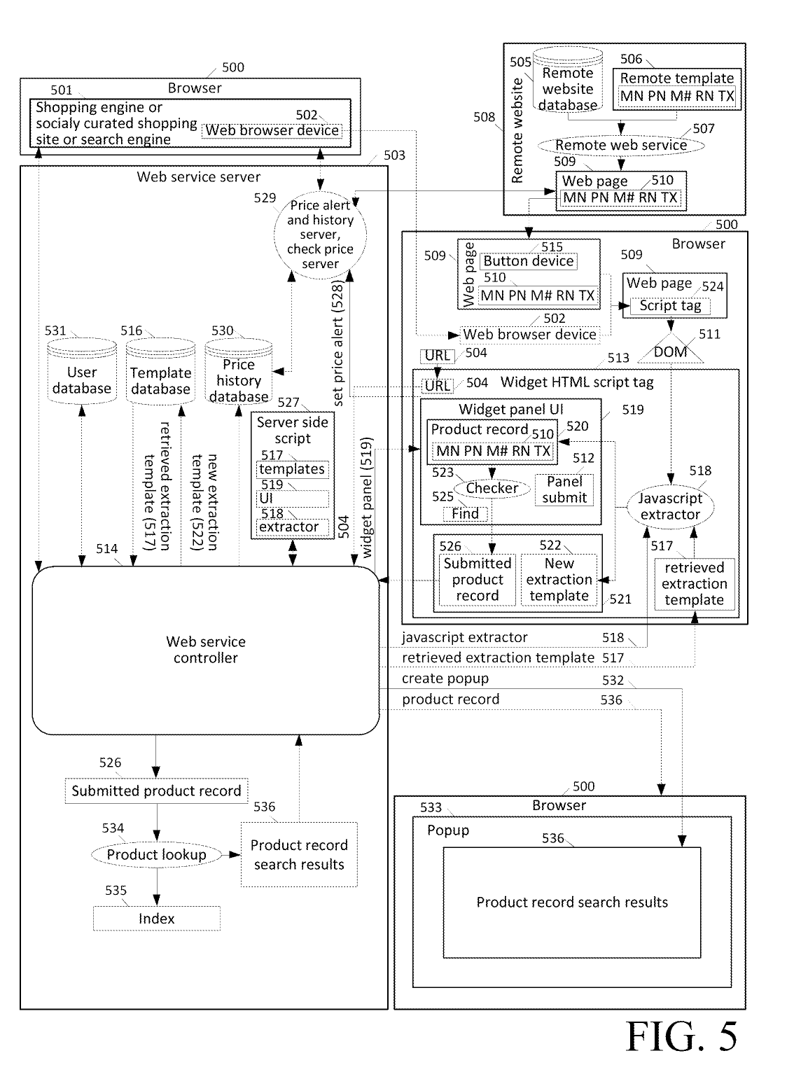

Turning now to FIG. 5, in one embodiment of the present invention, the user navigates to a remote page containing a product data record via the page URL. The user runs the web browser device on the page in the browser. The root URL is looked up in the extraction template database, and if the extraction template is found it is returned to the user. The user presses the FIND button 525 on the web browser device panel 519 to search for the product in the product index 535. If a new extraction template was created by the web browser device then the new extraction template is sent to the extraction template database 516. The extracted product record 520 in the web browser device panel is sent to web services controller 514. The web service then sends the product record to the look up 534 which queries the index. If the query returns a search result then it is sent back to the web service and the web service sends the product search result 536 to the popup 533 or browser tab. The browser popup displays the product search results and the user than selects the URL and goes to a remote website where they view the product information. A user can use our web browser to identify and associate data field value and name pairs on an HTML web page in order to send a search message back to the database server. This in effect is an advanced search because the search string is separated in phrases and the semantic type of each phrase in the search string is identified. The remote advanced search feature from a remote web site has the advantage of bringing the search facility and search results to the remote web page location the user is currently browsing. The remote advanced search feature saves the user from having to copy strings from different locations in the web page to a search box in another browser window or tab or to an excel spreadsheet or word processing document. The data record information in the web page is extracted by one of the methods described above, the data record is transmitted to the search engine, the data record is looked up in the index and the search results are returned to the browser, and appear in a browser popup. The user can use the advanced search process to also identify the rich attributes on a page and return the rich attributes with the search to enhance the search from the remote site, leading to a more specific search result.

The structured information which will be sent to the server is enclosed in the HTML markup containing the 3^{rd} party predefined set of data field names and the corresponding data field values includes the retailer and/or manufacturer logos, the retailer and/or manufacturer names, the product name, the model number, the product picture, the sale price, the description, and any other interesting data field values on the page. Note that the HTML markup containing the 3^{rd} party predefined set of data field names and the corresponding data field values is not visible in the browser window and that a second set of identical data field values are in a separate HTML markup section are visible in the browser window.

If the page at the site does not yet contain a template and the web browser device panel contains no data and the user does not want to create the extraction template then the user may request that the system ask someone else to create the extraction template for them. The request will be sent from the web browser device to the server where the request to create the extraction template is sent to the website's administrators and to users who have indicated that they will create templates to all users. The list of template creation requests can appear on the user's wall. Users can click on the extraction template creation request and can then go to the site where they will create the extraction template and upload it to the server. The server can optionally prompt the user to add the extracted product record to their collection. The server will then send a notice to the user that requested the extraction template be created. The user which sent the request will see a notification in their inbox that the extraction template has been created. They can click on the notice, see the link to original page that they sent the extraction template creation request from, go to the original page, and extract and save the data to one of their collections. The request system offers an advantage over systems that are non-cooperative in nature. One user may request help from another user to create a template. The two users do not need to know each other. The helping user may gain points in a game mechanics system or points which may be redeemed for other benefits such as discounts or credits on purchases. If no user responds to the extraction template creation request then a website's operator can make the extraction template for the user. The notification system works the same way in this case. There may be a time limit placed on responding to template creation requests.

Therefore the web browser device will transmit constant bit to the server so that the server can extract the same data from the same location in current and other web pages from the same site. The cleaner will extract the additional instances of the specification name/value pairs, features, and/or colors from the page using the repeating pattern extraction engine. The site is thus giving website explicit permission to extract the data from the page using a template that is stored on a remote server.

Selection of text in an HTML page by our web browser device. More than one data field value about a product web page or other type of data record web page may be contained in a single HTML markup tag pair. An example of a page that contains information in multiple places that may be used to identify and segment the multiple data field values in the HTML tag pair is as follows:

<title> Sony - S2134 - UnderwaterCamcorder </title>
<div> Sony S2134 UnderwaterCamcorder </div>

where the title of the web page contains the manufacturer name, the model number, and the product name. The user will right click on the information that appears in the page with in a rectangle, select the information, and associate it with a data field name. The problem is that three data field values appear in the same rectangle and multiple data field names need to be associated with the data field value. The solution is to allow the user to associate more than one data field name with the rectangle and to store the relative order of the data. This is a problematic approach without a semantic analysis engine that will separate the multiple data field values that are extracted from the single HTML tag pair. The data field values can be identified by semantic analysis in a process that runs on the server. The semantic analysis includes the identification of token that are manufacturer or retailer names, alphanumerics, prices, and which appear in other parts of the page.

The title contains separators ‘-’ which were inserted by the web master to assist search engines in parsing the title. The title information is automatically extracted from the web page and sent to the server along as part of the data record. The segmented title information is then matched against the strings in the other extracted data record fields. Longest substring matches in the example between the title and the string(s) in a particular field, along with semantic type information assists the server in identifying and segmenting the multiple data field values in the HTML tag pair for both the user during the selection of DFNs when using the web browser device and by the automatic extraction tool. In the extraction template created by the web browser device the HTML tag pair will contain 3 data field names. The server side cleaner will identify the multiple field values and extract them and associate them with their respective data field names. The cleaner can generate additional information about the HTML tag pair contents and add it to the data record template that the user created. The data record template is then passed to the automatic extraction process which will extract the data from all of the pages on the site. The automatic extraction process can use an unmodified extraction template to extract the multiple data values between the HTML tag pair, a modified data record template to attempt to identify and segment the multiple data values between the HTML tag pair, or can defer segmentation to the cleaner which can attempt to identify the multiple data values between the HTML tag pair using semantic analysis or attempt to use the extraction template information about the multiple data values between the HTML tag pair. Additional symbols which appear in product records, such as trademark or registered symbols, currency symbols, separators, constants, and data field names are used during the segmentation process. Additional segmentation of the product name in particular can be done if there are specifications present in the page, the title, the breadcrumb, and the product name. The user selects each of these page elements and associates them with a data field name using the right click menu. The server side will use the single specification name and value pair or line to extract the repeating pattern from the page.

The DOM along with the extraction template and extracted values are then passed to a series of modules. Each of the modules is responsible for cleaning one of the data field value types. There are modules for prices, features, specifications, colors, ratings, manufacturer and retailer names. Each of these modules uses template paths and extracted values to identify the exact DOM element which was selected by the web browser device as the container the information. The purpose of the price module is to extract currency and value of the price. In this process, a currency dictionary is used to identify the currency, and price is tokenized to identify the numeric value of the price. The manufacturer module is used to extract manufacturer name. The manufacturer name may be missing from the original record or may contain additional information, or may be in a different data field value such as product name. In the process of identifying the manufacturer name, the listing of existing manufacturer names is used in a form of a dictionary. Other information from the page, such as the title of the page may be used in this process. Additional data field name dictionary may be used. This dictionary contains data field names which often go next to the manufacturer name on pages. The features module completes the extraction of features. The original path and value are used to identify selected DOM element. Then a set of similar paths is found on the page (so called repeating paths). These paths are further grouped and the values from these paths are extracted as features. The specification module extracts specifications. It is similar to the extraction of the features. The same repeating path logic is used but this time specification name and value pairs are extracted. The retailer name module is used if retailer name is missing in the original record. The retailer name may be extracted from the URL or title of the page. The color module extracts color names or color/pattern swatches (small images describing the color). The color name dictionary is used to identify the color elements on the page. Then the repeating paths are found and grouped in order to extract all colors from the page. The data cleaner can perform the following operations: (1) Remove extra text from the extracted data field values. Example, if the manufacturer name is extracted from the copyright field then the string can be analyzed and words can be looked up in a manufacturer name dictionary located in the server. (2) Normalize the extracted values such as retailer and manufacturer names using a predefined lookup table containing the synonym and base names. (3) Repeating lists of information such as features or specifications composed of a specification attribute name, value, and optional metric (a specification tuple) can be extracted from the original page using an XPATH specified by the user to the block containing the repeating pattern, a row containing a feature or complete specification tuple or a specification value or name. (4) Normalize the specification attribute names using a predefined lookup table containing the synonym and base specification attribute names.

The data records representing the same product records from different retailers and possibly the manufacturer of the product are presented as different records in the search results. As a consequence the user must manually compare the prices for the same product from different sources. In order to provide an efficient mechanism for the user to find the best price it is desirable to normalize the product records. Records are identified for the same product at the same site and a single record is selected as a canonical product record for the particular product that is located at different web sites. The canonical product record has references to the each of the product records located at different web sites. The same product may be found at different sites. The product records from the different sites which contain the same product record are identified and a single record that points to all instances of the product at different sites is produced.

The data field names and values, as well as the specification attribute names and values, are normalized. The names are normalized using a synonym dictionary. The numerical specification values are normalized using the metrics. A voting system is used to select the product classification category(s) for the product based on the product classification category(s) which are found in each of the product records for the same product from the different web sites.

The normalization process involves creating a canonical record for the product attributes in the product record and a list of the seller specific attributes such as price, taxes, shipping, social opinions about the seller reputation with respect to the product category associated with the product, seller policies such as return periods and warranties, seller product knowledge, and the social reputation of the seller with respect to the product, product category, and social interaction with customers. All of the above types of information are available in various combinations in retailer product records and reviews.

Extracted product records from different retailer and manufacturer sites which are classified and normalized/de-duplicated and are then grouped together by manufacturer name/model name/number/UPC and other methods facilitate efficient end user search. The advantages of indexing and search for the end user of a normalized set of data records is well understood by those versed in the state of the art.

Creating a single product record with a master set of product attributes and a list of retailer attributes that can be displayed as a single record in a search result that links to a detailed list of the retailer attributes facilitates a more efficient decision making process for the consumer. For example, the consumer can then compare the prices offered from different retailers. Product records from the web browser device extraction process, automatic extraction process and which are downloaded using a data feed or other method are converted, normalized, cleaned, classified, and indexed.

The extraction template is then used to automatically extract the data from all pages at the site that have the same page structure as the page that the extraction template was created from. Variations in page layout are handled by the automatic extraction engine. Search results containing structured data (data records) are presented to the user. Structured data records extracted from one page can be indexed. Faceted search can be used in the conjunction with the index to specify fine grained requirements for a search. This has significant advantages over searching unstructured text.

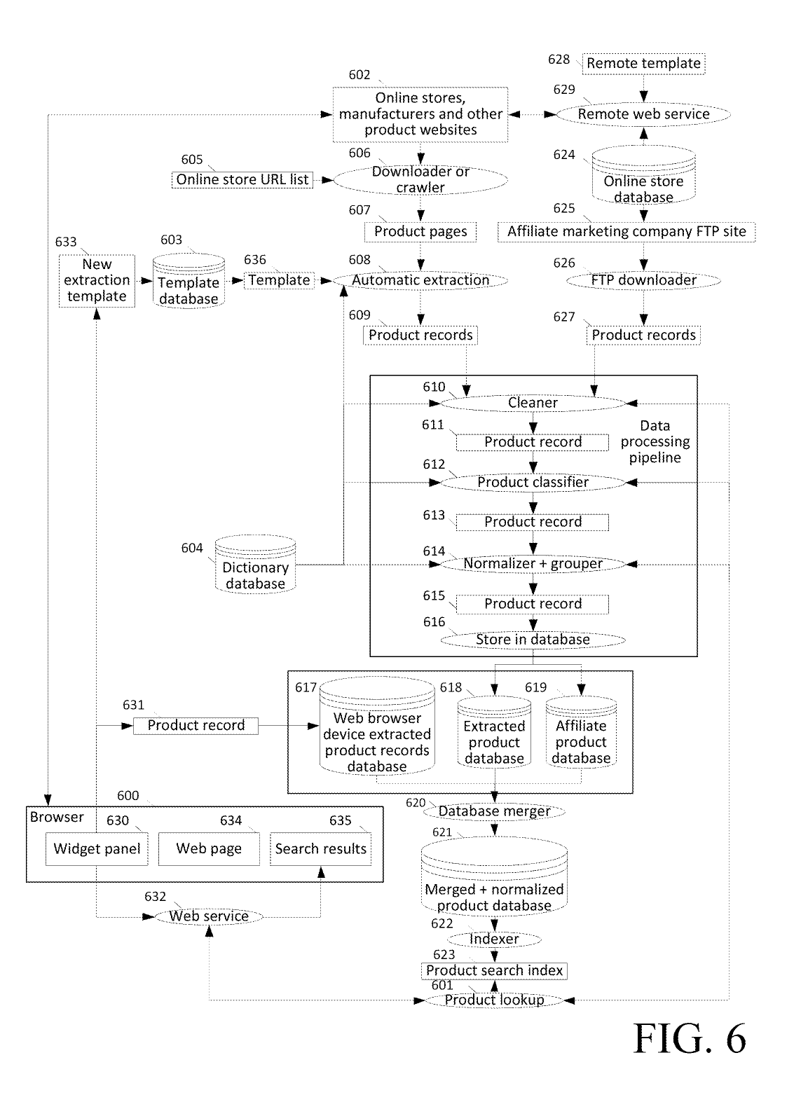

Turning now to FIG. 6, the following flows are shown: 1) affiliate marketing flow, 2) automatic extraction flow, 3) web browser device flow, 4) database merge flow, 5) price history server flow, and 6) template checker flow.

The affiliate flow does the following: the product record information in the online store database 624 at the affiliate marketing FTP website 625 is accessed by the ftp down loader 626 which fetches the product record data feed 627.

The automatic extraction flow does the following. A product information web site 602 is connected to the remote web service 629 that reads remote template(s) 628 containing the data field name variables, and remote online store database 624 to generate the online store site 602. The page downloader or crawler 606 reads a list of sites or pages from the online store URL list 605 and downloads the product pages 607.

The user can optionally search for a product using the widget panel 630 which sends the product record from the current web page 634 to the web service 632 which forwards the request to product lookup 601 which queries the product search index 623 which returns a product search result 635 to the browser 600 which displays the product search result. The advantage of this aspect of the invention is that the user can search for product information on remote product information web sites without leaving the product information web page.

The downloader and crawler 606 download pages from sites which contain data records. The downloader and crawler use the online store URL list 605 to download the product pages 607. The downloaded pages are then used in conjunction with the selected corresponding site template 636 from template database 603 by the automatic extractor 608 which extracts the product records from all pages matching the site template. A site may have more than one site template. The product pages are processed by the automatic extractor which sends the root URL of each page that it is processing to the extraction template database 603 and retrieves the web browser device extraction template. The web browser device extraction template is converted to an automatic extraction template. The automatic extractor extracts the structured data record from each product information page using the automatic extraction template and creates a product record 609.

The affiliate and automatic extraction flows each are read by the cleaner 610. The cleaner analyses each downloaded product record and produces a cleaned product record 611. The cleaner moves data field values and partial data field values from one data field to another, removes extraneous text, verifies the correctness of the data field values, and calculates statistics on the number of good/bad data field values using semantic checking Cleaned product records are then classified by the product classifier 612. The product classifier matches data records to one or more product classification tuples from the product classification tuple list using words from the data record which are product classification base or synonym words. The classified data records 613 are normalized by the normalizer 614. The normalizer will de-duplicate the product record stream, group records together which are the same record found at different sources (e.g. stores, shopping engines, socially curated sites, blogs, and manufacturer sites), refine the classification of a group of the same product records from different sources using methods such as voting. Further normalization steps can also be performed. The automatic extraction, cleaner, product classifier, normalizer and grouper stages communicate with the dictionary database 604. The dictionary looks up token(s) and returns semantic type information. Synonyms are converted to base words. The dictionary information is used by each pipe stage to process the data record. The resulting cleaned, classified and normalized product records 615 are saved 616 in the affiliate product database 619.

The user runs the widget 630 in a web browser 600 and creates a new extraction template 633 and a product record 631 from a product information web page 634 which is inserted into the extraction template database 603 it can be converted into a structured data extraction process template which is created in the automatic extraction 608 step. The web browser device new extraction template is converted to an automatic structured data extraction process template which is used to do the structured data extraction 608 of all pages matching the page layout that the web browser device extraction template was created from. All pages are downloaded from the site. Each web page from the same site is tested to see if it matches the structured data extraction template. If there is a match the data record is extracted from the matching pages. The extracted record is cleaned, classified, normalized, and stored in a database or index. The extraction process 608 can then generate a merged/normalized database 621.

The web browser device extracted product records database 617, extracted product database 618 and affiliate product database 619 are merged by the database merger 620 and a merged product database 621 created. The merged product database is then indexed by the indexer 622 and an index 623 is created.

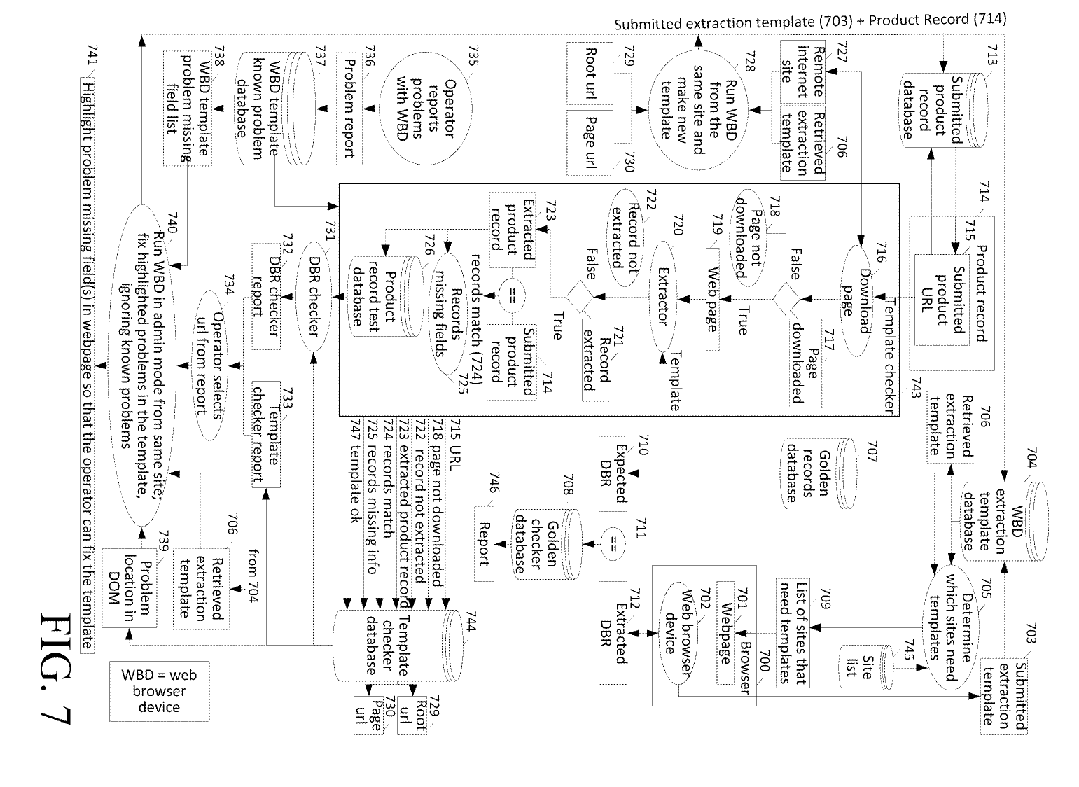

Turing now to FIG. 7, the extraction template checker can either check the extraction template in real time and return feedback to the user about the quality of the extraction template or the extraction template checker will run a periodic batch job to check all of the extraction templates in extraction template database. The extraction template checker report and the extraction template web browser device stat server template checker report are available on the admin panel for the template checker. The product extraction templates are checked by the extraction template checking system, which notifies operators and users as the page(s) change that the extraction template(s) need to be updated, then the updated templates are sent to the web browser device extraction template database, and the updated extraction templates are then used to extract the data. Without a template checking and updating system a price alert system will fail if the structure of the product page changes.

The extraction template server has a data record extraction template checking system as shown in FIG. 7. Users may not always create correct or complete data record templates. Records are extracted from pages using the extraction templates. The pages may change after the template is created. The web page used to create the extraction template may change. The data record template checking system detects these changes, errors, errors of omission, and other template related issues. A user opens a browser 700. The user navigates to a product information page on a remote web site 701. The user presses the web browser device (WDB) 702 and then the user runs the widget as described earlier in this patent. The web browser device 702 submits the product record 714 to the submitted product record database 713 and the submitted extraction template 703 to the web browser device template database 704. After the user submits the template to the widget template database the widget template is then checked for correctness. The template checking algorithm is described below.

As a separate issue the “determine which sites need templates” 705 compares the template database against the site list 745 and the golden records database 707 to make the “list of sites that need templates” 709. The golden record database contains the expected product records 710 which is compared to the extracted data record 712 and produces a match report 711 which is saved to the golden checker database 708 and a golden checker report 746 is generated.

The submitted product record database 713 contains product records 714 each of which contains the submitted product URL 715 for the page that the record was extracted from. The data record template checking system 743 downloader 716 periodically attempts to download the page at the URL 715. The system checks if the page was downloaded 717. If the page was not downloaded then the “page not downloaded” message 718 is sent to the template checker database 744. If the web page 719 was downloaded then the extractor 720 will retrieve the extraction template(s) 706 for the site from the extraction template database 704 and attempt to extract the product record 723 from the page. If the product record extracted check 721 reports that the record was not extracted then the “record not extracted” message 722 which includes the URL 715 for the page is sent to the template checker database 744. If the extracted product record 723 is extracted it is inserted into the template checker database 744 and the product record test database 726. The extracted product record 723 is compared against the submitted product record 714. A “match/mismatch” message 724 and a “template ok” message 747 is sent to the template database 744. The extracted product record is then checked for missing fields. If there are data field names that are present in the product page and the corresponding data field values are missing in the extracted product record then the “record missing information” message 725 plus the name(s) and location(s) of the missing fields are sent to the template checker database 744.

Operators can report problems 735 with the widget due to javascript, CSS and HTML incompatibilities and other problems on web pages/sites. The problem reports 736 are submitted to the web browser device template known problem database 737.

After all of the submitted product records have been checked the DBR checker 731 checks the product records in the product record test database 726 and generates a DBR checker report 732 which is read by an operator, along with the template checker report 733 which is generated from the template checker database 744. The operator then selects a URL 734 which has reported missing fields to execute the widget in administrative mode 740, using inputs in addition to the retrieved template 706. The additional widget inputs are the problem locations in the DOM 739 and the web browser device template problem missing field list 738 which is read from the widget template known problem database 737 using the site page URL 730 as the look up key. If the operator gets a report of a page not downloaded 718 then the template checker database 744 will send a report with the page url to rerun the extractor on. The fields with errors are surrounded with red instead of blue rectangles in the web page 741.

The operator will get a report from the template checker database 744 of the pages which no longer exist on the website (from page not downloaded error message 718). The operator will run the widget 728 on a new page from the site 727 so that a new submitted page URL in the new submitted product record 715 is associated with the retrieved extraction template 706. The submitted product URL 715 will be used in the next run of the template checker to check if the product record is extracted correctly by the extraction template and extractor.

The operator also will get a report from the template checker database 744 of the pages which the extractor cannot extract the record from (from “record not extracted” error message 718 or the “template not ok” error message 724 or the “records do not match” error message 724 or the “record missing info” error message 725). The operator will run the widget on a new page from the remote internet site 727 so that a new submitted page URL in the new submitted product record 725 is associated with the retrieved extraction template 703. The submitted product URL 715 will be used in the next run of the template checker to check if the product record is extracted correctly by the extraction template and extractor.

Verification of data transmitted via the website's button and form with name value pairs can be done via several mechanisms: comparison to previously extracted data, automatic and manual voting, user reputations, and operator verification. One possible problem with the button is if the page has missing data due to data being deleted from the back site database. Some users may deliberately submit bad data. The system needs to detect the bad records. The quality of the submitted data needs to be measured.

The extraction process is transformative in nature, thereby complying with the copyright fair use doctrine. The data extracted from the page is presented to the user in the panel. If the user chooses to do so, some data in the panel may be edited. For example, the company name that owns the site may be extracted from the copyright notice or some other field on the page which is in a fixed position on each page constructed from the same template. In addition edited and unedited data in the web browser device panel can be marked as constant throughout the site. Examples of constant data on a product page include the name of the site and the site logo. The extraction process on flash pages may require that the user take a snapshot of a flash image that cannot be extracted. The snapshot is then uploaded to the popup and is added to the data record. The transformation process includes resizing the images, determining the maximum dimension for the images in the x and y dimensions. Additional transformations include automatically classifying and cleaning the data using a data cleaner, normalizing the data field name(s), specification attribute names, and specification attribute values. Further normalization includes inter record normalization using all of the information in the data records. Normalization of data records is done by comparing the fields in different records and sorting the records by those fields.

Users view many websites for items of interest and they want a tracking or bookmarking system to capture the items of interest at different sites for future retrieval and viewing. Once users have related items, they want to decide who to share them with by selecting permission level, request recommendations from friends, the world, experts, or social connections in their social graph. That recommendation can be a vote, written opinion, or request for alternatives. Users also want to copy items from other user's collections. Users may also want to suggest to shopping engines what products or brands should be in the shopping engine database and index, by selecting the information on a product web page and sending the products and/or brands to the search engine.

The user can view a list of products and add extracted structured product information from a store or manufacturer or other product information source to a collection of items in a user profile on a social network. First, the user logs into the website using their user name and password. After logging in, the user profile page appears. The user profile page contains the information that the user added by the user, such as photos (biography, and other user information), lists (your collections, groups, questions/answers, followers, and following) and the latest activity related to each of the user's collections of information. Other users can add comments about the user or to any object stored on the user page such as a product record, a question, or a group. The latest user additions to each collection (internal or external product page database records-from web pages) also appear on the user page. The user can click on a collection name and go to the page containing the set of database records belonging to that collection. The word internal and external can appear in the hover bubble to identify internal and external data records (e.g. products). Data records contain data field name(s) and data field value(s) that are shown on the collection page. A product data record has many fields such as, a category, a manufacturer name, a product name, an image, a description, specifications, etc.

The user created lists which display data records from either external websites or the site's internal database are shown on the users pages at the site. In this embodiment the list of data record lists is accessed from the user profile page. Each list is accessed via a URL which links to a page which shows the data records in the list, clicking on a picture shows the view with a left hand control panel with left and right arrows and a larger picture of the item selected from the previous page in the right column. Alternatively the data records can be displayed using an on demand or “lazy loading” mechanism which is activated by the user pulling down the scroll bar or clicking in the empty part of the scrollbar. In a further alternate implementation clicking on the data record in the list opens a new page dedicated to the product record.

In addition to adding product information to the user's collection from third party sites (external products), the user can also add product information from the product search engine index/database which is connected to and part of the social network by going to a product page, clicking on add to collection, and selecting a collection to add the product to (internal product). The product will be added to the user collection and can be viewed via the user's profile page. Internal and external products can be mixed and matched in the user collections. A distinction is made between internal and external products on the user pages using an internal or external label on products. External products in collections can be associated with a canonical data record from the search engine database/index either manually by the user or automatically by the search engine normalization engine. Collections from users can be displayed in a global list viewable by the world unless otherwise restricted to a specific user list or group(s) by the user. The collections can be searched and listed in a search result format. The collections can be sorted by date, popularity (voting), size, and other criteria.

In addition, the information sent to the server by the user can be used as part of the information to identify websites of interest to extract data from, and form extraction templates from the user generated templates. User identified web sites have a higher interest level than non-user identified web sites. This is analogous to a page rank for pages. Users indicate that they are interested in the site and submit pages of interest. The data on those sites can then be extracted using the extraction templates.

Users can receive points for adding to their collections, creating collections, commenting on other collections, voting on items in a collection or other collections, asking questions and answering questions, joining groups that have collections, adding collection(s) to a group or their own profile. The points can be used for game mechanics to rank the users on the site and reward the users according to rank or achievement. User can receive a commission for sales of the products that they have submitted. The first user to add a record can receive the commission if the system can deduplicate the same product record submitted from the same site.

Trends can be determined by analyzing the types of goods, brands, and product categories users are adding to their collections. Brand managers are interested in tracking the product and brand interests of users. Brands can obtain valuable information by analyzing this information and by interacting with users on a social network where product information has been retrieved from third party sites.

Users can create collections to save products they like, either from an outside site, or from our site using the index or from other users on our site. They can also follow collections from other users and comment on collections, or make them private so other users can't see them. Users can submit items to their collections directly from their cell phone or mobile device, including scanning the bar code for the item, or using the GPS location of the store to give feedback about the purchase of the item and the location of the purchase, as well as feedback on the shopping experience at the store and other opinions about the physical store or personnel or store policies. This information about the store can be added to the user curated data about the store on the social networking site. Additional information from the purchase can be captured by photographing the receipt for the purchase or scanning the bar code of the purchase using a mobile device and then uploading it to a collection for future use. This additional product purchase information can be added to the user curated lists. Once the data has been added to the user lists the user can add user alerts to the individual products or a single or all collections. The alerts include number of days to the last day to return an item, number of days to the last day for a warranty repair.

The website can maintain a system which tracks the store and manufacturer policies with respect to returns, repairs, and exchanges. This system can be used to push the relevant policies to the user collection data records to enable an alert system described above. The store and manufacturer policy system can be populated either by the stores and manufacturers or by users via a form on the website or mobile application.

Users may also desire to track other information related to the product such as the store the item was purchased from, the date, the store's and manufacturer's warranty policies, the store's return policy, the serial number of the item, and any other information related to returning or obtaining a warranty repair or exchange for a product.

Note that the use of products does not limit the current invention to structured product data. The present invention can be used to extract information from any type of web page which contains structured information such as financial, sports, and political data. Capturing any kind of structured information from web pages and real world events and storing them in user curated lists is an application of the describe invention. For example, similar information can be tracked for other activities such as movies. The movie ticket can be scanned, the location of the theater can be noted, the data and time of the event can be recorded, the cost of the ticket can be recorded, etc.

Optionally, the server system can check, clean, verify, classify, and normalize the data records which are stored in user lists. The extracted external data records in the user lists are matched against canonical data records in the normalized database. An extracted external data record in a user list is then put in a list in the normalized database so that there is relationship between the normalized record and the extracted external data records. The relationship between the normalized record and the extracted external data record is also stored in the user list.

### Exemplary Computer System of the Invention

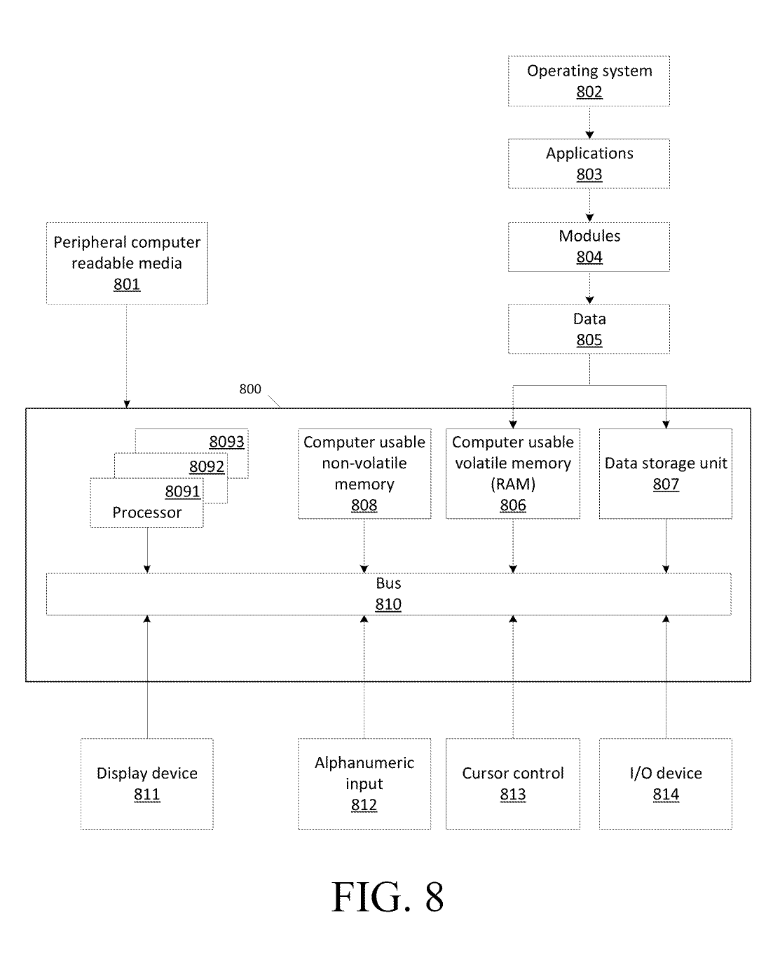

With reference now to FIG. 8, portions of the technology for providing computer-readable and computer-executable instructions that reside, for example, in or on computer-usable media of a computer system. That is, FIG. 8 illustrates one example of a type of computer that can be used to implement one embodiment of the present technology.

Although computer system 800 is an example of one embodiment, the present technology is well suited for operation on or with a number of different computer systems including general purpose networked computer systems, embedded computer systems, routers, switches, server devices, user devices, various intermediate devices/artifacts, standalone computer systems, mobile phones, personal data assistants, and the like.

In one embodiment, computer system 800 includes peripheral computer readable media 801 such as, for example, a floppy disk, a compact disc, and the like coupled thereto.

Computer system 800 also includes an address/data bus 810 for communicating information, and a processor 8091 coupled to bus 810 for processing information and instructions. In one embodiment, computer system 800 includes a multi-processor environment in which a plurality of processors 8091, 8092, and 8093 are present. Conversely, computer system 800 is also well suited to having a single processor such as, for example, processor 8091. Processors 8091, 8092, and 8093 may be any of various types of microprocessors. Computer system 800 also includes data storage features such as a computer usable volatile memory 806, e.g. random access memory (RAM), coupled to bus 810 for storing information and instructions for processors 8091, 8092, and 8093.

Computer system 800 also includes computer usable non-volatile memory 808, e.g. read only memory (ROM), coupled to bus 810 for storing static information and instructions for processors 8091, 8092, and 8093. Also present in computer system 800 is a data storage unit 807 (e.g., a magnetic or optical disk and disk drive) coupled to bus 810 for storing information and instructions. Computer system 800 also includes an optional alpha-numeric input device 812 including alpha-numeric and function keys coupled to bus 810 for communicating information and command selections to processor 8091 or processors 8091, 8092, and 8093. Computer system 800 also includes an optional cursor control device 813 coupled to bus 810 for communicating user input information and command selections to processor 8091 or processors 8091, 8092, and 8093. In one embodiment, an optional display device 811 is coupled to bus 810 for displaying information.

Referring still to FIG. 8, optional display device 811 may be a liquid crystal device, cathode ray tube, plasma display device or other display device suitable for creating graphic images and alphanumeric characters recognizable to a user. Optional cursor control device 813 allows the computer user to dynamically signal the movement of a visible symbol (cursor) on a display screen of display device 811. Implementations of cursor control device 813 include a trackball, mouse, touch pad, joystick or special keys on alphanumeric input device 812 capable of signaling movement of a given direction or manner of displacement. Alternatively, in one embodiment, the cursor can be directed and/or activated via input from alphanumeric input device 812 using special keys and key sequence commands or other means such as, for example, voice commands.

Computer system 800 also includes an I/O device 814 for coupling computer system 800 with external entities. In one embodiment, I/O device 814 is a modem for enabling wired or wireless communications between computer system 800 and an external network such as, but not limited to, the Internet. Referring still to FIG. 8, various other components are depicted for computer system 800. Specifically, when present, an operating system 802, applications 803, modules 804, and data 805 are shown as typically residing in one or some combination of computer usable volatile memory 806, e.g. random access memory (RAM), and data storage unit 807. However, in an alternate embodiment, operating system 802 may be stored in another location such as on a network or on a flash drive. Further, operating system 802 may be accessed from a remote location via, for example, a coupling to the Internet. In one embodiment, the present technology is stored as an application 803 or module 804 in memory locations within RAM 806 and memory areas within data storage unit 807.

### Exemplary System Architecture of the Invention

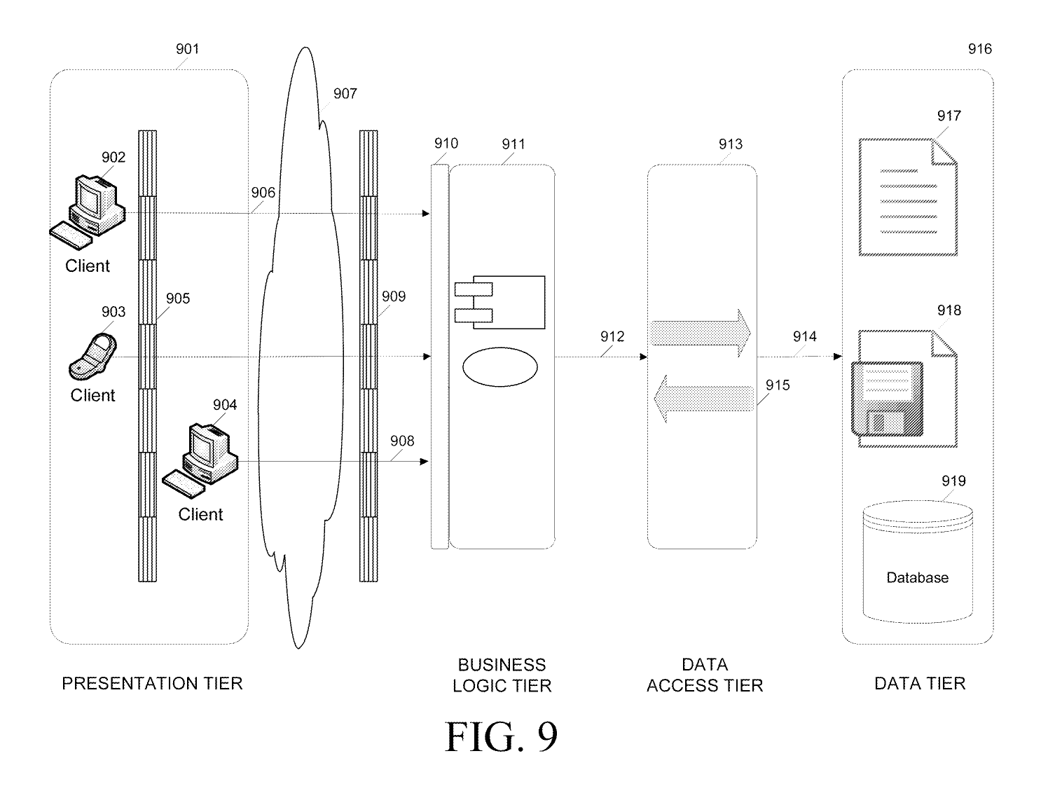

An exemplary system architecture of the invention is described below in connection with FIG. 9. According to an embodiment of the present invention, the system may be comprised at least in part of off-the-shelf software components and industry standard multi-tier (a.k.a. “n-tier”, where “n” refers to the number of tiers) architecture designed for enterprise level usage. One having ordinary skill in the art will appreciate that a multitier architecture includes a user interface, functional process logic (“business rules”), data access and data storage which are developed and maintained as independent modules, most often on separate computers.

According to an embodiment of the present invention, the system architecture of the system comprises a Presentation Logic Tier 901, a Business-Logic Tier 911, a Data-Access Tier 913, and a Data Tier 916.

The Presentation Logic Tier 901 (sometimes referred to as the “Client Tier”) comprises the layer that provides an interface for an end user (i.e., an Asserting Agent, Sponsoring Agent, Neutral Agent and/or a Challenging Agent) into the application (e.g., session, text input, dialog, and display management). That is, the Presentation Logic Tier 901 works with the results/output 906, 908 of the Business Logic Tier 911 to handle the transformation of the results/output 906, 908 into something usable and readable by the end user's client machine 902, 903, 904. Optionally, a user may access using a client machine 902 that is behind a firewall 905, as may be the case in many user environments.

The system uses Web-based user interfaces, which accept input and provide output 906, 908 by generating web pages that are transported via the Internet through an Internet Protocol Network 907 and viewed by the user using a web browser program on the client's machine 902, 904. In one embodiment of the present invention, device-specific presentations are presented to mobile device clients 903 such as smartphones, PDA, and Internet-enabled phones. In one embodiment of the present invention, mobile device clients 903 have an optimized subset of interactions that can be performed with the system, including browsing campaigns, searching campaigns, and sponsoring campaigns. In one embodiment of the invention, mobile device clients 903 can share campaigns on social media, email, or text messaging from the mobile device.

According to an embodiment of the present invention, the Presentation Logic Tier 901 may also include a proxy 910 that is acting on behalf of the end-user's requests 906, 908 to provide access to the Business Logic Tier 911 using a standard distributed-computing messaging protocol (e.g., SOAP, CORBA, RMI, DCOM). The proxy 910 allows for several connections to the Business Logic Tier 911 by distributing the load through several computers. The proxy 910 receives requests 906, 908 from the Internet client machines 902, 904 and generates html using the services provided by the Business Logic Tier 911

The Business Logic Tier 911 contains one or more software components for business rules, data manipulation, etc., and provides process management services (such as, for example, process development, process enactment, process monitoring, and process resourcing).

In addition, the Business Logic Tier 911 controls transactions and asynchronous queuing to ensure reliable completion of transactions, and provides access to resources based on names instead of locations, and thereby improves scalability and flexibility as system components are added or moved. The Business Logic Tier 911 works in conjunction 912 with the Data Access Tier 913 to manage distributed database integrity. The Business Logic Tier 911 also works in conjunction with the Testing Tier to assess Innovations and examine results.

Optionally, according to an embodiment of the present invention, the Business Logic Tier 911 may be located behind a firewall 909, which is used as a means of keeping critical components of the system secure. That is, the firewall 909 may be used to filter and stop unauthorized information to be sent and received via the Internet-Protocol network 907.

The Data-Access Tier 913 is a reusable interface that contains generic methods 915 to manage the movement 914 of Data 919, Documentation 917, and related files 918 to and from the Data Tier 916. The Data-Access Tier 913 contains no data or business rules, other than some data manipulation/transformation logic to convert raw data files into structured data that Innovations may use for their calculations in the Testing Tier.

The Data Tier 916 is the layer that contains the Relational Database Management System (RDBMS) 919 and file system (i.e., Documentation 917, and related files 918) and is only intended to deal with the storage and retrieval of information. The Data Tier 916 provides database management functionality and is dedicated to data and file services that may be optimized without using any proprietary database management system languages. The data management component ensures that the data is consistent throughout the distributed environment through the use of features such as data locking, consistency, and replication. As with the other tiers, this level is separated for added security and reliability.

The present technology may be described in the general context of computer-executable instructions stored on computer readable medium that may be executed by a computer. However, one embodiment of the present technology may also utilize a distributed computing environment where tasks are performed remotely by devices linked through a communications network.

It is to be understood that the exemplary embodiments are merely illustrative of the invention and that one skilled in the art may devise many variations of the above-described embodiments without departing from the scope of the invention. It is therefore intended that all such variations be included within the scope of the following claims and their equivalents.

What is claimed is:

1. A method for extracting a data record from a web page, said method comprising:
a. accessing the web page with a web browser;
b. activating a web browser device in the web page;
c. associating an extractor with a data record type on the web page;
d. extracting the data record associated with the data record type; and
e. storing said data record in a second data store wherein there is an association between a data field name in said data record in said first data store and a second data field name in the extraction template in said second data store.

2. The method of claim 1 wherein the data record is a hidden data record.

3. The method of claim 1 wherein the data record is visible data record on the web page, further comprising extracting the data associated with the data record type by:
i. selecting a data field value on said web page;
ii. associating a data field name with said data field value;
iii. calculating an XPATH value of said data field value on said web page;
iv. creating an extraction template comprising said data field name and said XPATH value using said web browser device; and
v. storing said extraction template in a first data store.

4. The method of claim 1 further comprising automatically retrieving an extraction template for the web page.

5. The method of claim 2 further comprising storing the hidden data record in an industry standard format and associating the hidden data record with a hidden data record template and XPATH location of the hidden data record and is associated with a root URL for a web site associated with the web page.

6. The method of claim 1 further comprising displaying said data field value in said web browser device.

7. The method of claim 1 further comprising automatically displaying the data record in a panel, accepting a description and collection from a user, and submitting the data record, the description and the collection to the first data store.

8. The method of claim 2 further comprising checking validity of said extraction template by re-extracting a current data field value and comparing to said data field value and finding any data field names present in the web page which are missing in the extraction template or the hidden data record.

9. The method of claim 2 further comprising accepting from a user an indication that the data field value is a constant wherein said constant becomes part of the extraction template or hidden data record template, and said constant is displayed in subsequent extraction processes.

10. The method of claim 1 further comprising storing said data field value with said data field name, said XPATH value and associating a root URL name in an extraction template in said first data store.

11. The method of claim 1 further comprising classifying said data field value using a product classifier and assigning a product classification to said data field value.

12. The method of claim 1 further comprising aggregating a plurality of said data field names and said data field values in said second data store into user defined collections.

13. The method of claim 1 further comprising, associating plurality of said extraction templates with a user for measuring the quality and quantity of extraction templates generated by said user.

14. The method of claim 1 further comprising adding user defined descriptions to said data field value in said second data store.

15. The method of claim 1 further comprising allowing a second user accessing said web page from which the data record was extracted or said extraction template was created or retrieved to extract a current data field value from said web page.

16. The method of claim 1 further comprising extracting all of the elements of a list associated with said data field value using a repeating structured pattern associated with said data field name and said XPATH value.

17. The method of claim 1 further comprising selecting said data field value using a predefined extraction template retrieved from said first data store.

18. The method of claim 2 further comprising selecting said data field value extracted from the hidden data record.

19. The method of claim 1 further comprising selecting said data field value using by searching for a predefined data field name on said web page.

20. The method of claim 1 further comprising converting said extraction template from said first data store into an automatic data extraction template to extract current data field values from all web pages at the root web site which matches said template.

21. The method of claim 2 further comprising converting said hidden record data template from said first data store into an automatic data extraction template to extract current data field values from all web pages at the root web site which matches said template.

22. The method of claim 1 further comprising cleaning said data field value, classifying said data field value, normalizing said data field value, storing said data field value and indexing said data field value.

23. The method of claim 1 further comprising adding date and purchase location information associated with said data field value to said second data store.

24. The method of claim 1 further comprising comparing a plurality of data field values from said second data store by a user in the in a social network or a shopping engine and storing the comparison for viewing by said user or other social network members.

25. A method for implementing a browser based information transmission method comprising:
a. extracting a data record from a web page;
b. adding said data record to a user profile on a social network; and
c. sharing said data record with a plurality of users wherein each of said users can comment, copy, compare, vote on, or access the web page.

26. The method of claim 20 further comprising combining said data record with plurality of other extracted data records to form a collection.

27. The method of claim 21 further comprising storing said collection in a searchable index.

28. A method for finding a product search result from a product record on a web page, said method comprising:
a. accessing the web page with a web browser;
b. activating a web browser device on the web page in a web browser;
c. transmitting the product record to the web service controller;
d. extracting a product record from the web page;
e. querying a data store and associating the product record with a product search result;
f. returning the product search result from the web service controller to the web browser device;
g. displaying the product search result in the web browser device.

29. The method of claim 28 wherein the data record is a visible data record, further comprising: transmitting a root URL from the web browser device to a web service controller; associating the root URL with an extraction template; returning the extraction template from the web service controller to the web browser device; and extracting a product record from the web page using the extraction template.
